(19) United States
(12) Patent Application Publication
(10) Pub. No.: US 2026/0287058 A1
(43) Pub. Date: Sep. 24, 2026

(54) SYSTEMS, ASSEMBLIES, APPARATUSES, AND METHODS PROVIDING ENHANCED FLUID SEAL FOR HIGH-POWER PUMPS

(71) Applicant: Vulcan Industrial Holdings, LLC, Houston, TX (US)

(72) Inventors: Kyle Ellisor, Katy, TX (US); Richard Peer, Tomball, TX (US); Akhil Alex, Houston, TX (US); Steven Newberg, Willis, TX (US); Chris Leake, Sugar Land, TX (US)

(21) Appl. No.: 19/696,501

(22) Filed: Jun. 3, 2026

Related U.S. Application Data
(62) Division of application No. 18/655,707, filed on May 6, 2024, now Pat. No. 12,650,171.
(60) Provisional application No. 63/500,834, filed on May 8, 2023.

(51) Int. Cl. F16J 15/10

(52) U.S. Cl. CPC F16J 15/106

(57) ABSTRACT

Systems, assemblies, apparatuses, and methods herein may provide an enhanced fluid seal between two components. A seal may include an annular seal body having a groove face, a sealing face opposite the groove face, a first lateral face, and a second lateral face opposite the first lateral face. The groove face may have an at least partially convex groove edge, and the sealing face may have an at least partially concave sealing edge and a protrusion. The first and second lateral faces may be oblique with respect to one another, and the groove face, the sealing face, the first lateral face, and/or the second lateral face may cause the seal to deform in a groove of a first one of the two components when a second one of the two components presses against the sealing face, thereby to enhance the fluid seal between the two components.

### CROSS REFERENCE TO RELATED APPLICATIONS

This application is a divisional of U.S. Non-Provisional application Ser. No. 18/655,707, filed May 6, 2024, titled “SYSTEMS, ASSEMBLIES, APPARATUSES, AND METHODS PROVIDING ENHANCED FLUID SEAL FOR HIGH-POWER PUMPS,” now U.S. Pat. No. 12,650,171, issued Jun. 9, 2026, which claims priority to, and the benefit of U.S. Provisional Application No. 63/500,834, filed May 8, 2023, titled “SYSTEMS, ASSEMBLIES, APPARATUSES, AND METHODS PROVIDING ENHANCED FLUID SEAL FOR HIGH-POWER PUMPS,” the disclosures of which are incorporated herein by reference in their entirety.

### TECHNICAL FIELD

The present disclosure relates to systems, assemblies, apparatuses, and methods providing an enhanced fluid seal for high-power pumps and, more particularly, to systems, assemblies, apparatuses, and methods providing an enhanced fluid seal between components in high-power pumps.

### BACKGROUND

Pumps may be used to transfer a fluid having a first pressure from one location to another location at a second pressure greater than the first pressure. Some types of pumps may be subject to fluctuating interior pressure during operation. For example, a chamber in the interior of a reciprocating pump may be exposed to a relatively lower pressure as a plunger moves in a first direction, creating suction to draw fluid into the chamber via an intake port, and thereafter, may be exposed to relatively higher pressure as the plunger moves in a second direction, increasing the pressure of the fluid and discharging the fluid at the increased pressure from a discharge port.

Pumps may often include a number of fluid seals to prevent fluid from passing from one portion of the pump to another or from the interior of the pump to the exterior of the pump. An example of such a seal may be used to provide a fluid seal between mating components of the pump. For example, some types of pumps may include various ports that receive another component, and it may be important to provide a fluid seal between the port and the other component. For example, a cover or a sleeve maybe received in the port, and a seal may be provided between the cover or sleeve and the port in order to provide a fluid seal between the two components. In order to help anchor the seal relative to the cover or sleeve, a gland or groove may be provided on the cover, on the sleeve, or in the port, and the seal may be at least partially received in the groove. Some types of pumps, as noted above, may experience relatively large fluctuations in pressure, which may cause the seal to deflect or compress during pressure fluctuations. Applicant has recognized that this may result in causing the seal and/or the groove to degrade relatively more quickly, for example, as fluid pumped during operation of the pump may migrate into the groove between the deflected or compressed seal and the groove. The wear may be particularly pronounced, depending on the contents of the fluid. For example, abrasive particles and/or corrosive fluids may accelerate the wear of the seal and/or the groove, potentially leading to shortened service lives of the seal and one or more of the components, as well as increased downtime, reducing the efficiency of operations using the pump.

An example high-power pump may be used to pump fracturing fluid at high pressures and high flow rates during a hydraulic fracturing operation. For example, a hydraulic fracturing operation involves pumping a fracturing fluid at high flow rates and high pressures sufficient to fracture a reservoir formation to allow hydrocarbons to more easily flow from the formation toward a wellbore for production. Such high rates of flow and high pressures may result in significant wear to components associated with the fluid flow, such as high-power pumps used to pump the fracturing fluid. In addition, the fracturing fluid may contain substances, for example, proppants and fluids having abrasive and corrosive characteristics, and thus, seals and components associated with the fracturing operation may exhibit relatively higher wear rates or failure rates. As a result, components associated with pumps, such as seals, may be particularly susceptible high wear rates and failure rates, thereby requiring relatively more frequent maintenance, repair, or replacement, which may increase downtime for the hydraulic fracturing operation and reduce efficiency and productivity. For example, the seals and related components may degrade with use in such harsh conditions, as described above, creating leakage at the seals and related components, which reduces the efficiency and capabilities of the pump.

For at least these reasons, Applicant has recognized that it may be desirable to provide seals, related assemblies, and related methods resulting in relatively longer service lives that reduce downtime associated with use in a high-power pump. At least some examples described herein may address one or more of the above-noted potential issues, as well as possibly others.

### SUMMARY

As referenced above, it may be desirable to provide seals, related assemblies, and related methods that result in relatively longer service lives that reduce downtime associated with use in a high-power pump, such as, for example, seals and components used in the oil and gas industry, where the operating conditions and fluids may present a particularly harsh environment. In some embodiments, the systems, assemblies, apparatuses, and methods presented herein may provide a relatively enhanced fluid seal between pump components, such as seals and adjacent components, which may result in relatively reduced damage, deformation, wear, and/or leakage during operation of high-power pumps including the seals and components. For example, in some embodiments, the seals and associated components may be configured to reduce or prevent damage, deformation, wear, and/or leakage of the seals and associated components during operation of a high-power pump.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face, and the seal cross-section may have a groove edge at least partially defined by the groove face. The groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. The first lateral edge and the second lateral edge may be oblique with respect to one another. One or more of the groove face, the sealing face, the first lateral face, or the second lateral face may be positioned to cause the seal to deform in the groove of the one of the first component or the second component when the other of the first component or the second component presses against the protrusion in a direction toward the groove face, thereby to expand the annular seal body laterally outward from the first lateral face and the second lateral face, thereby to enhance the fluid seal between the first component and the second component.

According to some embodiments, a method to enhance a fluid seal between two components of a pump may include inserting an annular seal into an annular groove of a first component of the pump. The annular seal may include a groove face and a sealing face opposite the groove face. The groove face, in an undeformed condition, may be substantially convex, and the sealing face, in the undeformed condition, may be substantially concave. The annular groove may have a groove cross-section at least partially defined by a bottom of the annular groove, a first side wall of the annular groove, a second side wall of the annular groove opposite the first side wall, and an open portion of the annular groove opposite the bottom of the annular groove and extending between the first side wall and the second side wall. Inserting the annular seal into the annular groove may result in at least a portion of the groove face of the annular seal contacting the bottom of the annular groove and at least a portion of sealing face of the annular seal protruding beyond the open portion of the annular groove. The method further may include assembling a second component of the pump relative to the first component of the pump, and compressing, via the second component, so as to deform the annular seal when positioned in the annular groove, causing the groove face to abut and substantially fill the bottom of the annular groove and extend from the first side wall to the second side wall, so as to enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body also may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. One or more of the groove face, the sealing face, the first lateral face, or the second lateral face may be positioned to cause the seal to deform in the groove of the one of the first component or the second component when the other of the first component or the second component presses against the protrusion in a direction toward the groove face, thereby to expand the annular seal body laterally outward from the first lateral face and the second lateral face and preload the seal in the groove, thereby to enhance the fluid seal between the first component and the second component.

According to some embodiments, a seal to enhance a fluid seal between a first component and a second component may include an annular seal body. The annular seal body may have a groove face positioned to face a groove of the first component, and a sealing face opposite the groove face and positioned to face away from the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. The first lateral edge and the sealing edge may meet at a first sealing edge intersection, and the second lateral edge and the sealing edge may meet at a second sealing edge intersection. The groove edge may at least partially define a groove edge apex, and the protrusion may at least partially define a protrusion apex. One or more of (a) the first sealing edge intersection or (b) the second sealing edge intersection, and the groove edge apex may at least partially define a first radial dimension, and the groove edge apex and the protrusion apex may at least partially define a second radial dimension. The first radial dimension may be greater than the second radial dimension, such that as the second component compresses the seal at the first sealing edge intersection and the second sealing edge intersection, the groove edge apex causes the protrusion to be compressed against the second component, thereby to preload the seal and enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further may have a first lateral face extending between the groove face and the sealing face, and a second lateral face opposite the first lateral face and extending between the groove face and the sealing face. The annular seal body also may have a seal cross-section at least partially defined by the groove face, the sealing face, the first lateral face, and the second lateral face. The seal cross-section may have a groove edge at least partially defined by the groove face, and the groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. The groove edge and the sealing edge may at least partially define a spring, such that as the other of the first component or the second component compresses the seal, the groove edge causes the protrusion to be pressed outward against the other of the first component or the second component, thereby to preload the seal and enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. The seal cross-section may at least partially define a seal cross-sectional area. The groove edge may at least partially define a convex radius between the first lateral edge and the second lateral edge, and the seal cross-sectional area and the convex radius may be selected to: (a) cause the seal to expand laterally outward against side walls of the groove when the other of the first component or the second component compresses the seal, and (b) press the protrusion against the other of the first component or the second component when the other of the first component or the second component compresses the seal, thereby to enhance the fluid seal between the first component and the second component.

According to some embodiments, a cover and seal assembly for a fluid end of a high-power pump may include a cover having a substantially cylindrical cover body having an outer surface including an annular groove extending around the cover body. The cover and seal assembly further may include a seal at least partially received in the annular groove. The seal may include an annular seal body, and the annular seal body may have a groove face facing the annular groove of the cover, and a sealing face opposite the groove face. The annular seal body further may include a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. The first lateral edge and the second lateral edge may be oblique with respect to one another. One or more of the groove face, the sealing face, the first lateral face, or the second lateral face may be positioned to cause the seal to deform in the groove of the cover when the fluid end presses against the protrusion in a direction toward the groove face, thereby to expand the annular seal body laterally outward from the first lateral face and the second lateral face, thereby to enhance the fluid seal between the cover and the fluid end.

According to some embodiments, a fluid end for a high-power pump may include a fluid end housing at least partially defining a chamber, a suction port providing a fluid path into the chamber, a discharge port providing a fluid path from the chamber, and an access port providing access to the chamber. The fluid end further may include a cover received in the access port, and a seal between the cover and the access port providing a fluid seal between the cover and the fluid end housing. The seal may include an annular seal body having a groove face facing the annular groove of the cover, and a sealing face opposite the groove face. The annular seal body further may include a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. The first lateral edge and the second lateral edge may be oblique with respect to one another. One or more of the groove face, the sealing face, the first lateral face, or the second lateral face may be positioned to cause the seal to deform in the groove of the cover when the fluid end presses against the protrusion in a direction toward the groove face, thereby to expand the annular seal body laterally outward from the first lateral face and the second lateral face, thereby to enhance the fluid seal between the cover and the fluid end.

According to some embodiments, a sleeve and seal assembly for a fluid end of a high-power pump may include a sleeve having a substantially cylindrical sleeve body having an outer surface including an annular groove extending around the sleeve body. The sleeve and seal assembly further may include a seal at least partially received in the annular groove. The seal may include an annular seal body, and the annular seal body may have a groove face facing the annular groove of the sleeve, and a sealing face opposite the groove face. The annular seal body further may include a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. The first lateral edge and the second lateral edge may be oblique with respect to one another. One or more of the groove face, the sealing face, the first lateral face, or the second lateral face may be positioned to cause the seal to deform in the groove of the sleeve when the fluid end presses against the protrusion in a direction toward the groove face, thereby to expand the annular seal body laterally outward from the first lateral face and the second lateral face, thereby to enhance the fluid seal between the sleeve and the fluid end.

According to some embodiments, a fluid end for a high-power pump may include a fluid end housing at least partially defining a chamber, a suction port providing a fluid path into the chamber, a discharge port providing a fluid path from the chamber, and a plunger port positioned to at least partially receive therein a reciprocating plunger. The fluid end further may include a sleeve received in the plunger port, and a seal between the sleeve and the plunger port providing a fluid seal between the sleeve and the fluid end housing. The seal may include an annular seal body having a groove face facing the annular groove of the sleeve, and a sealing face opposite the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. The first lateral edge and the second lateral edge may be oblique with respect to one another. One or more of the groove face, the sealing face, the first lateral face, or the second lateral face may be positioned to cause the seal to deform in the groove of the sleeve when the fluid end presses against the protrusion in a direction toward the groove face, thereby to expand the annular seal body laterally outward from the first lateral face and the second lateral face, thereby to enhance the fluid seal between the sleeve and the fluid end.

According to some embodiments, a high-power pump may include a power end positioned to convert rotational power into reciprocating motion, a plunger connected to the power end and positioned to reciprocate, and a fluid end connected to the power end. The fluid end may include a fluid end housing at least partially defining a chamber, a suction port providing a fluid path into the chamber, a discharge port providing a fluid path from the chamber, and an access port providing access to the chamber. The fluid end further may include a cover received in the access port, and a seal between the cover and the access port providing a fluid seal between the cover and the fluid end housing. The fluid end may at least partially receive therein the plunger as the plunger reciprocates, thereby to draw-in fluid at a first pressure via the suction port during movement of the plunger in a first direction and discharge the fluid at a second pressure greater than the first pressure via the discharge port during movement of the plunger in a second direction. The seal may include an annular seal body. The annular seal body may have a groove face facing the annular groove of the sleeve, and a sealing face opposite the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. The first lateral edge and the second lateral edge may be oblique with respect to one another. One or more of the groove face, the sealing face, the first lateral face, or the second lateral face may be positioned to cause the seal to deform in the groove of the sleeve when the fluid end presses against the protrusion in a direction toward the groove face, thereby to expand the annular seal body laterally outward from the first lateral face and the second lateral face, thereby to enhance the fluid seal between the cover and the fluid end.

According to some embodiments, a high-power pump may include a power end positioned to convert rotational power into reciprocating motion, a plunger connected to the power end and positioned to reciprocate, and a fluid end connected to the power end. The fluid end may include a fluid end housing at least partially defining a chamber, a suction port providing a fluid path into the chamber, a discharge port providing a fluid path from the chamber, a plunger port, and a sleeve received in the plunger port. The sleeve may be positioned to at least partially receive therein the plunger as the plunger reciprocates, thereby to draw-in fluid at a first pressure via the suction port during movement of the plunger in a first direction and discharge the fluid at a second pressure greater than the first pressure via the discharge port during movement of the plunger in a second direction. The fluid end further may include a seal between the sleeve and the plunger port providing a fluid seal between the sleeve and the fluid end housing. The seal may include an annular seal body. The annular seal body may have a groove face facing the annular groove of the sleeve, and a sealing face opposite the groove face. The annular seal body further may include a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may be at least partially convex. The seal cross-section further may have a sealing edge at least partially defined by the sealing face, and the sealing edge may be at least partially concave and have a protrusion between the first lateral face and the second lateral face. The seal cross-section also may have a first lateral edge at least partially defined by the first lateral face, and a second lateral edge at least partially defined by the second lateral face. The first lateral edge and the second lateral edge may be oblique with respect to one another. One or more of the groove face, the sealing face, the first lateral face, or the second lateral face may be positioned to cause the seal to deform in the groove of the sleeve when the fluid end presses against the protrusion in a direction toward the groove face, thereby to expand the annular seal body laterally outward from the first lateral face and the second lateral face, thereby to enhance the fluid seal between the sleeve and the fluid end.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may be at least partially concave. The seal cross-section further may have a sealing edge at least partially defined by the sealing face, and the sealing edge may be at least partially concave. The seal cross-section also may have a first lateral edge at least partially defined by the first lateral face, and a second lateral edge at least partially defined by the second lateral face. The groove edge and the sealing edge may form an area between the first lateral edge and the second lateral edge having a relatively reduced thickness. One or more of the groove face, the sealing face, the first lateral face, or the second lateral face may be positioned to cause the seal to deform in the groove of the one of the first component or the second component when the other of the first component or the second component presses against the sealing face in a direction toward the groove face, thereby to compress the area between the first lateral edge and the second lateral edge and expand the annular seal body laterally outward from the first lateral face and the second lateral face, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and the groove edge may at least partially define a groove recess. The seal cross-section further may have a sealing edge at least partially defined by the sealing face, and the sealing edge may be at least partially convex. The seal cross-section also may have a first lateral edge at least partially defined by the first lateral face, and a second lateral edge at least partially defined by the second lateral face. The first lateral edge, the sealing edge, and the second lateral edge may at least partially define a substantially continuous arc. One or more of the groove face, the sealing face, the first lateral face, or the second lateral face may be positioned to cause the seal to deform in the groove of the one of the first component or the second component when the other of the first component or the second component presses against the sealing face in a direction toward the groove face, thereby to push an area of the seal between the first lateral edge and the second lateral edge against the other of the first component or the second component and expand the annular seal body laterally outward from the first lateral face and the second lateral face and press against walls of the groove, thereby to enhance the fluid seal between the first component and the second component.

According to some embodiments, a seal to enhance a fluid seal between an outer surface of a first component having a substantially circular cross-section and an inner surface of a second component, may include a first annular seal body. The first annular seal body may have a first intermediate face positioned to face toward a groove of one of the first component or the second component, and a sealing face opposite the first intermediate face and positioned to face away from the first intermediate face. The first annular seal body further may have a first lateral face extending between the first intermediate face and the sealing face, and a second lateral face opposite the first lateral face and extending between the first intermediate face and the sealing face. The first annular seal body may have a first seal cross-section at least partially defined by the first intermediate face, the sealing face, the first lateral face, and the second lateral face. The first seal cross-section may have a first intermediate edge at least partially defined by the first intermediate face, and the first intermediate edge may be oblique with respect to a circumferential axis of the seal. The first seal cross-section further may have a sealing edge at least partially defined by the sealing face, and the sealing edge may be at least partially concave. The first lateral edge may be at least partially defined by the first lateral face. The first seal cross-section also may have a second lateral edge at least partially defined by the second lateral face, and the second lateral edge may be at least partially concave. The seal further may include a second annular seal body. The second annular seal body may have a groove face positioned to face the groove of the one of the first component or the second component, and a second intermediate face opposite the groove face and positioned to face away from the groove face. The second intermediate face may be adjacent the first intermediate face. The second annular seal body further may have a third lateral face extending between the groove face and the second intermediate face, and the third lateral face may provide an extension of the first lateral face. The second annular seal body also may have a fourth lateral face opposite the third lateral face and extending between the groove face and the second intermediate face, and the fourth lateral face may provide an extension of the second lateral face. The second annular seal body may have a second seal cross-section at least partially defined by the groove face, the second intermediate face, the third lateral face, and the fourth lateral face. The second seal cross-section may have a groove edge at least partially defined by the groove face, and a second intermediate edge at least partially defined by the second intermediate face. The second seal cross-section further may have a third lateral edge at least partially defined by the third lateral face, and a fourth lateral edge at least partially defined by the fourth lateral face. One or more of the first annular seal body or the second annular seal body may be positioned to cause the seal to deform in the groove of the one of the first component or the second component when the other of the first component or the second component presses against the sealing face of the first annular seal body in a direction toward the groove face, thereby to expand the first annular seal body and the second annular seal body outward from: (a) the first lateral face and the third lateral face, and (b) the second lateral face and the fourth lateral face, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body, further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and a sealing edge at least partially defined by the sealing face. The seal cross-section further may have a first lateral edge at least partially defined by the first lateral face, and a second lateral edge at least partially defined by the second lateral face. The groove edge may at least partially define a groove edge recess between the first lateral edge and the second lateral edge. The seal further may include an O-ring received in the groove edge recess of the groove face. One or more of the groove face, the O-ring, the sealing face, the first lateral face, or the second lateral face may be positioned to cause the seal to deform in the groove of the one of the first component or the second component when the other of the first component or the second component presses against the sealing face in a direction toward the groove face, thereby to expand the annular seal body laterally outward from the first lateral face and the second lateral face, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may include a groove face positioned to face a groove of one of the first component or the second component, and a sealing face opposite the groove face and positioned to face away from the groove face. The annular seal body further may include a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and a sealing edge at least partially defined by the sealing face. The seal cross-section further may have a first lateral edge at least partially defined by the first lateral face, and the first lateral edge may at least partially define a first lateral recess between the groove edge and the sealing edge. The seal cross-section also may have a second lateral edge at least partially defined by the second lateral face, and the second lateral edge may at least partially define a second lateral recess between the groove edge and the sealing edge. The seal further may include a first O-ring at least partially received in the first lateral recess of the first lateral face, and a second O-ring at least partially received in the second lateral recess of the second lateral face. One or more of the groove face, the first O-ring, the second O-ring, the sealing face, the first lateral face, or the second lateral face may be positioned to cause the seal to deform in the groove of the one of the first component or the second component when the other of the first component or the second component presses against the sealing face in a direction toward the groove face, thereby to expand the annular seal body laterally outward from the first lateral face and the second lateral face and press the first O-ring and the second O-ring against walls of the groove, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and a sealing edge at least partially defined by the sealing face. The seal cross-section further may have a first lateral edge at least partially defined by the first lateral face, and the first lateral edge and the groove edge may meet at a first groove edge intersection. One or more of the first lateral edge or the groove edge may at least partially define a first intersection recess at the first groove edge intersection. The seal cross-section also may have a second lateral edge at least partially defined by the second lateral face, and the second lateral edge and the groove edge may meet at a second groove edge intersection. One or more of the second lateral edge or the groove edge may at least partially define a second intersection recess at the second groove edge intersection. The seal further may include a first O-ring at least partially received in the first intersection recess, and a second O-ring at least partially received in the second intersection recess. One or more of the groove face, the first O-ring, the second O-ring, the sealing face, the first lateral face, or the second lateral face may be positioned to cause the seal to deform in the groove of the one of the first component or the second component when the other of the first component or the second component presses against the sealing face in a direction toward the groove face, thereby to expand the annular seal body laterally outward from the first lateral face and the second lateral face and press the first O-ring and the second O-ring against walls of the groove, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further may include a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and a sealing edge at least partially defined by the sealing face. The seal cross-section further may have a first lateral edge at least partially defined by the first lateral face, and a second lateral edge at least partially defined by the second lateral face. The sealing edge may at least partially define a plurality of sealing edge recesses between the first lateral edge and the second lateral edge. The seal further may include a plurality of O-rings. Each of the plurality of O-rings may be received in one of the plurality of sealing edge recesses of the sealing face. One or more of the groove face, the plurality of O-rings, the sealing face, the first lateral face, or the second lateral face may be positioned to cause the seal to deform in the groove of the one of the first component or the second component when the other of the first component or the second component presses against the plurality of O-rings in a direction toward the groove face, thereby to expand the annular seal body laterally outward from the first lateral face and the second lateral face, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and a sealing edge at least partially defined by the sealing face. The sealing edge may have a sealing edge recess. The seal cross-section further may include a first lateral edge at least partially defined by the first lateral face, and a second lateral edge at least partially defined by the second lateral face. The seal further may include an annular stiffener at least partially received in the sealing edge recess of the annular seal body. The annular stiffener may have a first stiffener face adjacent the sealing face of the annular seal body, and a second stiffener face opposite the first stiffener face. The annular stiffener further may have a stiffener cross-section at least partially defined by the first stiffener face and the second stiffener face. The stiffener cross-section may have a first stiffener edge at least partially defined by the first stiffener face, and the first stiffener edge may be at least partially convex. The stiffener cross-section further may have a second stiffener edge at least partially defined by the second stiffener face. One or more of the groove face, the sealing face, the first lateral face, the second lateral face, the first stiffener face, or the second stiffener face may be positioned to cause the seal to deform in the groove of the one of the first component or the second component when the other of the first component or the second component presses against outer edges of the sealing face and the second stiffener face in a direction toward the groove face, thereby to expand the annular seal body laterally outward from the first lateral face and the second lateral face, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and a sealing edge at least partially defined by the sealing face. The seal cross-section further may have a first lateral edge at least partially defined by the first lateral face, and a second lateral edge at least partially defined by the second lateral face. The seal further may include a plurality of stiffeners extending between the first lateral face and the second lateral face of the annular seal body. The plurality of stiffeners may be circumferentially spaced around the annular seal body. One or more of the groove face, the sealing face, the first lateral face, the second lateral face, or one or more of the plurality of stiffeners may be positioned to cause the seal to deform in the groove of the one of the first component or the second component when the other of the first component or the second component presses against the sealing face in a direction toward the groove face, thereby to expand the annular seal body laterally outward from the first lateral face and the second lateral face, thereby to enhance the fluid seal between the first component and the second component.

According to some embodiments, a seal to enhance a fluid seal between an outer surface of a first component having a substantially circular cross-section and an inner surface of a second component, may include a first annular seal body. The first annular seal body may have a first groove face positioned to face a groove of one of the first component or the second component, and a first sealing face opposite the first groove face and positioned to face away from the first groove face. The first annular seal body further may have a first lateral face extending between the first groove face and the first sealing face, and a second lateral face opposite the first lateral face and extending between the first groove face and the first sealing face. The first annular seal body may have a first seal cross-section at least partially defined by the first groove face, the first sealing face, the first lateral face, and the second lateral face. The first seal cross-section may have a first groove edge at least partially defined by the first groove face, and a first sealing edge at least partially defined by the first sealing face. The first seal cross-section further may have a first lateral edge at least partially defined by the first lateral face, and a second lateral edge at least partially defined by the second lateral face. The seal further may include a second annular seal body. The second annular seal body may have a second groove face positioned to face the groove of the one of the first component or the second component, and a second sealing face opposite the second groove face and positioned to face away from the second groove face. The second annular seal body further may have a third lateral face extending between the second groove face and the second sealing face, and a fourth lateral face opposite the third lateral face and extending between the second groove face and the second sealing face. The second annular seal body may have a second seal cross-section at least partially defined by the second groove face, the second sealing face, the third lateral face, and the fourth lateral face. The second seal cross-section may have a second groove edge at least partially defined by the second groove face, and a second sealing edge at least partially defined by the second sealing face. The second seal cross-section also may have a third lateral edge at least partially defined by the third lateral face and facing toward the second lateral edge, and a fourth lateral edge at least partially defined by the fourth lateral face. The seal also may include an annular stiffener between the first annular seal body and the second annular seal body and extending between the second lateral face and the third lateral face. One or more of the first annular seal body, the second annular seal body, or the annular stiffener may be positioned to cause the seal to deform in the groove of the one of the first component or the second component when the other of the first component or the second component presses against the first sealing face and the second sealing face in a direction toward the first groove face and the second groove face, thereby to expand the first annular seal body laterally outward from the first lateral face and the second annular seal body outward from the fourth lateral face, thereby to enhance the fluid seal between the first component and the second component.

According to some embodiments, a seal to enhance a fluid seal between an outer surface of a first component having a substantially circular cross-section and an inner surface of a second component, may include an annular seal body including a helically-wound material coil. The annular seal body may at least partially define a groove face positioned to face a groove of one of the first component or the second component, and a sealing face opposite the groove face and positioned to face away from the groove face. The annular seal body further may include a first lateral face extending between the groove face and the sealing face, and a second lateral face opposite the first lateral face and extending between the groove face and the sealing face. the annular seal body may have a seal cross-section at least partially defined by the groove face, the sealing face, the first lateral face, and the second lateral face. The seal cross-section may have a groove edge at least partially defined by the groove face, and a sealing edge at least partially defined by the sealing face. The seal cross-section further may have a first lateral edge at least partially defined by the first lateral face, and a second lateral edge at least partially defined by the second lateral face. One or more of the groove face, the sealing face, the first lateral face, or the second lateral face may be positioned to cause the seal to deform in the groove of the one of the first component or the second component when the other of the first component or the second component presses against the sealing face in a direction toward the groove face, thereby to expand the annular seal body laterally outward from the first lateral face and the second lateral face and press against walls of the groove, thereby to enhance the fluid seal between the first component and the second component.

According to some embodiments, a seal to enhance a fluid seal between an outer surface of a first component having a substantially circular cross-section and an inner surface of a second component, may include a first annular seal body. The first annular seal body may have a first groove face positioned to face a groove of one of the first component or the second component, and a first sealing face opposite the first groove face and positioned to face away from the first groove face. The first annular seal body further may have a first lateral face extending between the first groove face and the first sealing face, and a second lateral face opposite the first lateral face and extending between the first groove face and the first sealing face. The first annular seal body may have a first seal cross-section at least partially defined by the first groove face, the first sealing face, the first lateral face, and the second lateral face. The first seal cross-section may have a first groove edge at least partially defined by the first groove face, and a first sealing edge at least partially defined by the first sealing face. The first seal cross-section further may have a first lateral edge at least partially defined by the first lateral face, and a second lateral edge at least partially defined by the second lateral face. The seal further may include a second annular seal body. The second annular seal body may have a second groove face positioned to face the groove of the one of the first component or the second component, and a second sealing face opposite the second groove face and positioned to face away from the second groove face. The second annular seal body further may have a third lateral face extending between the second groove face and the second sealing face, and a fourth lateral face opposite the third lateral face and extending between the second groove face and the second sealing face. The second annular seal body may have a second seal cross-section at least partially defined by the second groove face, the second sealing face, the third lateral face, and the fourth lateral face. The second seal cross-section may have a second groove edge at least partially defined by the second groove face, and a second sealing edge at least partially defined by the second sealing face. The second seal cross-section further may have a third lateral edge at least partially defined by the third lateral face and facing toward the second lateral edge, and a fourth lateral edge at least partially defined by the fourth lateral face. The seal further may include an annular stiffener between the first annular seal body and the second annular seal body and extending between the second lateral face and the third lateral face. The annular stiffener may include a helically-wound material coil. The annular stiffener may at least partially define a stiffener groove face positioned to face the groove of one of the first component or the second component, and a stiffener sealing face opposite the stiffener groove face and positioned to face away from the stiffener groove face. The annular stiffener further may at least partially define a first lateral stiffener face extending between the stiffener groove face and the stiffener sealing face. The first lateral stiffener face may be adjacent the second lateral face. The annular stiffener also may at least partially define a second lateral stiffener face opposite the first lateral stiffener face and extending between the stiffener groove face and the stiffener sealing face. The second lateral stiffener face maybe adjacent the third lateral face. The annular stiffener may have a stiffener cross-section at least partially defined by the stiffener groove face, the stiffener sealing face, the first lateral stiffener face, and the second lateral stiffener face. The stiffener cross-section may have a stiffener groove edge at least partially defined by the stiffener groove face, and a stiffener sealing edge at least partially defined by the stiffener sealing face. The stiffener cross-section further may have a first lateral stiffener edge at least partially defined by the first lateral stiffener face, and a second lateral stiffener edge at least partially defined by the second lateral stiffener face. One or more of the first annular seal body, the second annular seal body, or the annular stiffener may be positioned to cause the seal to deform in the groove of the one of the first component or the second component when the other of the first component or the second component presses against the first sealing face and the second sealing face in a direction toward the first groove face and the second groove face, thereby to expand the first annular seal body laterally outward from the first lateral face and the second annular seal body outward from the fourth lateral face, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face. The groove edge may be one of at least partially concave or at least partially convex. The seal cross-section further may have a sealing edge at least partially defined by the sealing face, and the sealing edge may be one of at least partially concave or at least partially convex. The seal cross-section also may have a first lateral edge at least partially defined by the first lateral face, and a second lateral edge at least partially defined by the second lateral face. One or more of the groove face, the sealing face, the first lateral face, or the second lateral face may be positioned to cause the seal to deform in the groove of the one of the first component or the second component when the other of the first component or the second component presses against the sealing face in a direction toward the groove face, thereby to compress the area between the first lateral edge and the second lateral edge and expand the annular seal body laterally outward from the first lateral face and the second lateral face, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and a sealing edge at least partially defined by the sealing face. the seal cross-section further may have a first lateral edge at least partially defined by the first lateral face, and a second lateral edge at least partially defined by the second lateral face. One or more of the groove face, the sealing face, the first lateral edge, or the second lateral edge at least partially define an edge recess. The seal further may include an O-ring received in the edge recess. One or more of the groove face, the O-ring, the sealing face, the first lateral face, or the second lateral face may be positioned to cause the seal to deform in the groove of the one of the first component or the second component when the other of the first component or the second component presses against the sealing face in a direction toward the groove face, thereby to expand the annular seal body laterally outward from the first lateral face and the second lateral face, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may have a groove face positioned to face a groove of one of the first component or the second component, and a sealing face opposite the groove face and positioned to face away from the groove face. The annular seal body further may have a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and a sealing edge at least partially defined by the sealing face. The seal cross-section further may have a first lateral edge at least partially defined by the first lateral face, and a second lateral edge at least partially defined by the second lateral face. One or more of the annular seal body, the groove face, the sealing face, the first lateral face, or the second lateral face may at least partially define a recess. The seal further may include a stiffener at least partially received in the recess. One or more of the groove face, the sealing face, the first lateral face, the second lateral face, or the stiffener may be positioned to cause the seal to deform in the groove of the one of the first component or the second component when the other of the first component or the second component presses against the sealing face in a direction toward the groove face, thereby to expand the annular seal body laterally outward from the first lateral face and the second lateral face, thereby to enhance the fluid seal between the first component and the second component.

According to some embodiments, a seal to enhance a fluid seal between an outer surface of a first component having a substantially circular cross-section and an inner surface of a second component, may include an annular seal body. The annular seal body may include a helically-wound material coil. The annular seal body may at least partially define a groove face positioned to face a groove of one of the first component or the second component, and a sealing face opposite the groove face and positioned to face away from the groove face. The annular seal body further may at least partially define a first lateral face extending between the groove face and the sealing face, and a second lateral face opposite the first lateral face and extending between the groove face and the sealing face. The annular seal body may have a seal cross-section at least partially defined by the groove face, the sealing face, the first lateral face, and the second lateral face. The seal cross-section may have a groove edge at least partially defined by the groove face, and a sealing edge at least partially defined by the sealing face. The seal cross-section further may have a first lateral edge at least partially defined by the first lateral face, and a second lateral edge at least partially defined by the second lateral face. One or more of the groove face, the sealing face, the first lateral face, or the second lateral face may be positioned to cause the seal to deform in the groove of the one of the first component or the second component when the other of the first component or the second component presses against the sealing face in a direction toward the groove face, thereby to expand the annular seal body laterally outward from the first lateral face and the second lateral face and press against walls of the groove, thereby to enhance the fluid seal between the first component and the second component.

According to some embodiments, a method of installing a seal in a pump to enhance a fluid seal between two components of the pump, may include inserting an annular seal into an annular groove of a first component of the pump. The annular seal may include a groove face and a sealing face opposite the groove face. The groove face, in an undeformed condition, may be substantially convex and the sealing face, in the undeformed condition, may be substantially concave. The inserting may result in at least a portion of the groove face of the annular seal contacting a bottom of the annular groove and at least a portion of sealing face of the annular seal protruding beyond an open portion of the annular groove. The method further may include compressing, via a second component of the pump, so as to deform the annular seal when positioned in the annular groove, thereby to cause the groove face to abut and substantially fill a bottom of the annular groove and extend from a first side wall to a second side wall of the annular groove.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a schematic perspective section view of an example high-power pump and fluid end including example seals between example components of the high-power pump, according to embodiments of the disclosure.

FIG. 2 is a schematic side section view of the example high-power pump shown in FIG. 1, according to embodiments of the disclosure.

FIG. 3A is a schematic perspective view showing one of the example seals and example components shown in FIG. 1, according to embodiments of the disclosure.

FIG. 3B is a schematic side section view of the example seals and example components shown in FIG. 3A, according to embodiments of the disclosure.

FIG. 4A is a schematic perspective view showing another one of the example seals and example components shown in FIG. 1, according to embodiments of the disclosure.

FIG. 4B is a schematic side section view of the example seals and example components shown in FIG. 4A, according to embodiments of the disclosure.

FIG. 5A is a schematic perspective section view of an example seal, according to embodiments of the disclosure.

FIG. 5B is a schematic section view of the example seal shown in FIG. 5A, according to embodiments of the disclosure.

FIG. 5C is a schematic section view of the example seal shown in FIG. 5A, according to embodiments of the disclosure.

FIG. 5D is a schematic detailed section view of a portion of the example seal shown in FIG. 5A, according to embodiments of the disclosure.

FIG. 5E is a schematic detailed section view of a portion of the example seal shown in FIG. 5A, according to embodiments of the disclosure.

FIG. 6A is a schematic section view of the example seal shown in FIG. 5A in an uncompressed condition received in an example groove of a first example component, according to embodiments of the disclosure.

FIG. 6B is a schematic section view of the example seal shown in FIG. 5A in an example deformed and activated condition when an example second component compresses the seal received in an example groove in a substantially cylindrical outer surface of a first component, according to embodiments of the disclosure.

FIG. 6C is a schematic section view of the example seal shown in FIG. 5A in an example deformed and activated condition when an example second component compresses the seal received in an example groove in a substantially cylindrical inner surface of a first component, according to embodiments of the disclosure.

FIG. 7A is a schematic perspective section view of another example seal, according to embodiments of the disclosure.

FIG. 7B is a schematic section view of the example seal shown in FIG. 7A in an uncompressed condition, according to embodiments of the disclosure.

FIG. 8A is a schematic perspective section view of another example seal, according to embodiments of the disclosure.

FIG. 8B is a schematic section view of the example seal shown in FIG. 8A in an uncompressed condition, according to embodiments of the disclosure.

FIG. 9A is a schematic perspective section view of another example seal, according to embodiments of the disclosure.

FIG. 9B is a schematic section view of the example seal shown in FIG. 9A in an uncompressed condition, according to embodiments of the disclosure.

FIG. 10A is a schematic perspective section view of another example seal including an example O-ring, according to embodiments of the disclosure.

FIG. 10B is a schematic section view of the example seal shown in FIG. 10A in an uncompressed condition, according to embodiments of the disclosure.

FIG. 11A is a schematic perspective section view of another example seal including example O-rings, according to embodiments of the disclosure.

FIG. 11B is a schematic section view of the example seal shown in FIG. 11A in an uncompressed condition, according to embodiments of the disclosure.

FIG. 12A is a schematic perspective section view of another example seal including example O-rings, according to embodiments of the disclosure.

FIG. 12B is a schematic section view of the example seal shown in FIG. 12A in an uncompressed condition, according to embodiments of the disclosure.

FIG. 13A is a schematic perspective section view of another example seal including example O-rings, according to embodiments of the disclosure.

FIG. 13B is a schematic section view of the example seal shown in FIG. 13A in an uncompressed condition, according to embodiments of the disclosure.

FIG. 14A is a schematic perspective section view of another example seal including an example stiffener, according to embodiments of the disclosure.

FIG. 14B is a schematic section view of the example seal shown in FIG. 14A in an uncompressed condition, according to embodiments of the disclosure.

FIG. 15A is a schematic perspective section view of another example seal including example stiffeners, according to embodiments of the disclosure.

FIG. 15B is a schematic section view of the example seal shown in FIG. 15A in an uncompressed condition, according to embodiments of the disclosure.

FIG. 16A is a schematic perspective section view of another example seal including an example stiffener, according to embodiments of the disclosure.

FIG. 16B is a schematic section view of the example seal shown in FIG. 16A in an uncompressed condition, according to embodiments of the disclosure.

FIG. 17A is a schematic perspective section view of another example seal including an example helically-wound material coil, according to embodiments of the disclosure.

FIG. 17B is a schematic section view of the example seal shown in FIG. 17A in an uncompressed condition, according to embodiments of the disclosure.

FIG. 18A is a schematic perspective section view of another example seal including an example helically-wound material coil, according to embodiments of the disclosure.

FIG. 18B is a schematic section view of the example seal shown in FIG. 18A in an uncompressed condition, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

The present disclosure generally is directed to systems, assemblies, apparatuses, and methods that may provide a relatively enhanced fluid seal between pump components, such as seals and adjacent components, which may result in relatively reduced damage, deformation, wear, and/or leakage during operation of high-power pumps including the seals and components. For example, in some embodiments, the seals and associated components may be configured to reduce or prevent damage, deformation, wear, and/or leakage of the seals and associated components during operation of a high-power pump.

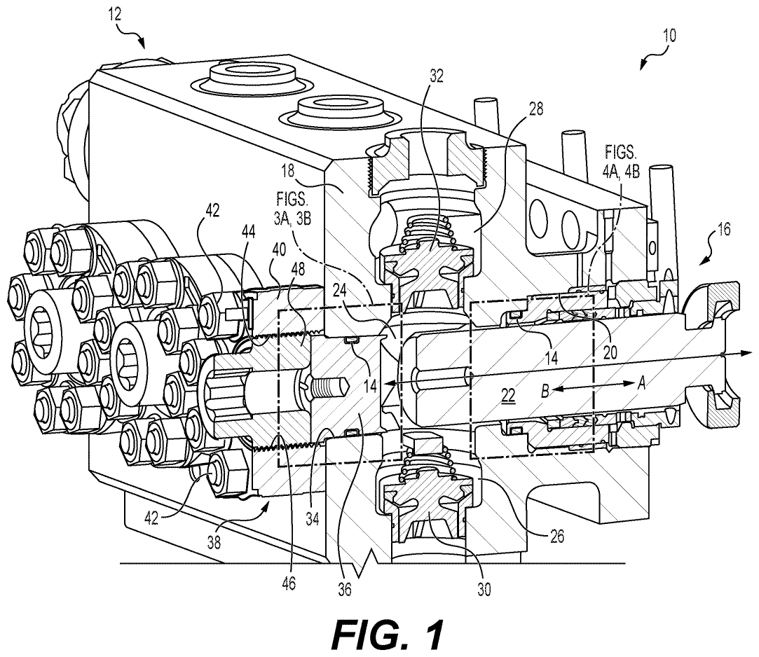

For example, FIG. 1 is a schematic partial perspective section view of an example pump 10, including an example fluid end assembly 12, and example seals 14 between example components of the pump 10, according to embodiments of the disclosure. The pump 10 may be any high-power pump, high-pressure pump, reciprocating pump, and/or high-flow rate pump suitable for pumping solids, semi-solids, slurries, liquids, fluids, or combinations thereof. In some embodiments, the pump 10 may be, for example, a hydraulic fracturing pump for pumping hydraulic fracturing fluid. Although embodiments of the pump 10 are described herein as being a “hydraulic fracturing pump” for pumping hydraulic fracturing fluid for the purpose of discussion, the pump 10 may be any other type of pump, such as, for example, any type of high-power pump, high-pressure pump, reciprocating pump, and/or high-flow rate pump suitable for pumping solids, semi-solids, slurries, liquids, fluids, or combinations thereof. In some embodiments, the pump 10 may be, for example, a hydraulic fracturing pump for pumping solids, semi-solids, slurries, liquids, fluids, or combinations thereof, such as hydraulic fracturing fluid.

For example, a reciprocating plunger pump may be used to pump a fracturing fluid at high flow rates and high pressures sufficient to fracture a reservoir formation to allow hydrocarbons to more easily flow from the formation toward a wellbore for production. A hydraulic fracturing operation may include as many as six or more hydraulic fracturing units, and each of the hydraulic fracturing units may include a prime mover, such as an electric motor or internal combustion engine, either directly connected, or connected via a transmission, to the reciprocating plunger pump to supply power to drive the reciprocating plunger pump to pump the fracturing fluid into the formation to stimulate production of the well. For example, typical flow rates for a hydraulic fracturing operation may range from about 1,500 to about 4,000 gallons per minute, and typical pressures may range from about 7,500 to about 15,000 pounds per square inch. Although many examples discussed in this disclosure are explained in relation to hydraulic fracturing pumps, such as reciprocating plunger pumps for pumping fracturing fluid and related methods, other flow control-related and/or pumping-related operations, components, and methods are contemplated.

As shown in FIG. 1, the example pump 10 may be a reciprocating plunger pump and may include the fluid end assembly 12 and a power end assembly 16. The power end assembly 16 may include, for example, a housing with mechanical power transmission components, such as a crankshaft, bearings supporting the crankshaft in the housing, crossheads, reduction gears, and/or connecting rods and plungers connected to the connecting rods. As shown in FIG. 1, the fluid end assembly 12 may include, for example, a fluid end housing 18 including one or more cylinders 20 in which respective plungers 22 reciprocate, one or more chambers 24 receiving fluid, one or more suction ports 26 for drawing fluid into the one or more chambers 24, and one or more discharge ports 28 for discharging fluid from the one or more chambers 24 at a higher pressure. For example, as each plunger 22, moved via operation of the crankshaft and a respective connecting rod of the power end assembly 16, at least partially retracts into a respective cylinder 20, fluid is drawn into the chamber 24 of the fluid end assembly 12 via the suction port 26 in the fluid end housing 18 while an intake valve 30 is open and a discharge valve 32 is closed. As each plunger 20 extends back toward the chamber 24, moved via operation of the crankshaft and the respective connecting rod of the power end assembly 16, pressurized fluid is discharged from the fluid end assembly 12 via the discharge port 28 in the fluid end housing 18 while the discharge valve 32 is open and the intake valve 30 is closed. The intake valve 30 and discharge valve 32 may be one-way valves or check valves, allowing fluid to flow only in a single direction, either into the fluid end housing 18 via the intake valve 30, or from the fluid end housing 18 via the discharge valve 32. In this example manner, the fluid end assembly 12 draws fluid into the fluid end assembly 12 at a first pressure and discharges the fluid from the fluid end assembly 12 at a higher pressure. In some pump embodiments, the fluid end assembly 12 may include multiple (e.g., two, three, four, or five) sets of intake passages, cylinders, plungers, and discharge passages to pump fluid at high pressures and/or high flow rates.

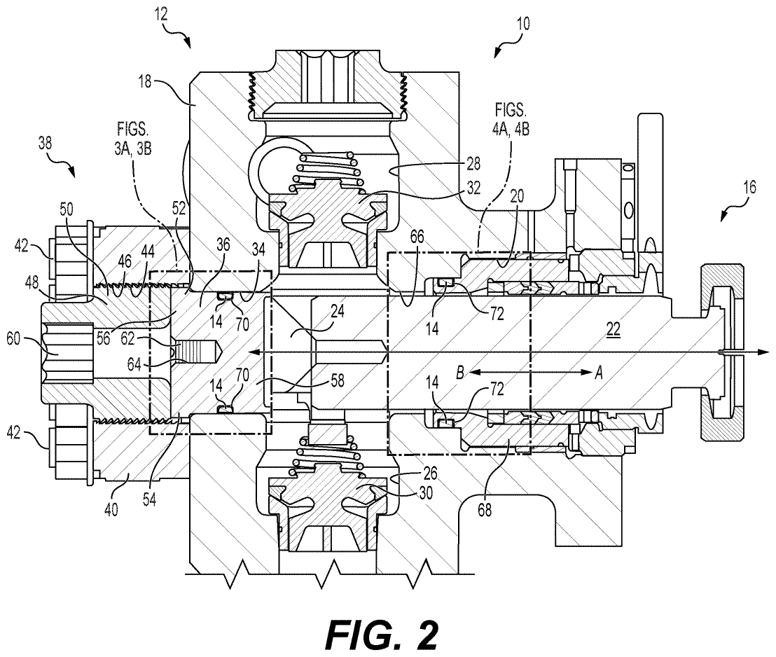

FIG. 2 is a schematic side section view of the example pump 10 shown in FIG. 1, according to embodiments of the disclosure. As shown in FIGS. 1 and 2, in some embodiments, the fluid end assembly 12 may include an access port 34 providing access to the chamber 24, for example, for use during assembly and/or maintenance of the fluid end assembly 12. The access port 34 may be selectively closed via a cover 36 received in the access port 34. In some embodiments, the access port 34 may be defined in the fluid end housing 18 by a circular aperture having an interior face having a substantially cylindrical configuration, for example, as shown in FIGS. 1 and 2. In some embodiments, the cover 36 may have a substantially circular cross-section and may have a substantially cylindrical configuration sized and shaped to fit within the interior face of the access port 34, for example, as shown in FIGS. 1 and 2. In some embodiments, the cover 36 may be sized and shaped to fit snugly within the access port 34. In some embodiments, a retainer assembly 38 may be used to secure the cover 36 within the access port 34. As shown, in some embodiments, the retainer assembly 38 may include an outer housing 40 configured to be secured to an exterior surface of the fluid end housing 18 adjacent the access port 34, for example, via one of more fasteners 42 (e.g., studs and nuts), as shown. The outer housing 40 may define a receiver aperture 44 provided with interior threads 46. The retainer assembly 38 further may include a retainer 48, which may include a substantially cylindrical body having exterior threads 50 configured to threadedly engage the interior threads of the outer housing 40. In some embodiments, the cover 36 may include a shoulder 52 and a flange 54 having an exterior end 56 opposite an interior end 58 facing the chamber 24. The shoulder 52 and flange 54 may be configured to abut the exterior surface of the fluid end housing 18 adjacent the access port 34. The retainer 48 may be threaded into the outer housing 40 and abut the exterior end of the cover 36, thereby to secure the cover 36 in the access port 34. As shown, in some embodiments, the retainer 48 may include a retainer recess 60 configured to be engaged by a tool for assisting the tightening and loosening of the retainer 48 relative to the outer housing 40 and the cover 36.

As shown in FIGS. 1 and 2, some embodiments of the cover 36 may include a cover recess 62 opening outward from the center of the exterior end 56 of the cover 36 surface and having interior threads 64. The cover recess 62 may be used to assist within removal of the cover 36, for example, to provide access to the chamber 24. For example, a tool may be used to engage the cover recess 62 and assist with pulling the cover 36 from the access port 34.

As shown in FIGS. 1 and 2, in some embodiments, the fluid end housing 18 may include a plunger port 66 and a sleeve 68 received in the plunger port 66. The plunger port 66 and the sleeve 68 may be substantially cylindrical, with the plunger port 66 having a substantially circular cross-section and the sleeve 68 having a substantially cylindrical outer surface received in the plunger port 66. The sleeve 68 may be configured to at least partially receive therein the plunger 22 as the plunger 22 reciprocates, thereby to draw fluid into the chamber 24 at a first pressure via the suction port 26 during movement of the plunger 22 in a first direction A and discharge the fluid from the chamber 24 at a second pressure greater than the first pressure via the discharge port 28 during movement of the plunger 22 in a second direction B, for example, as shown in FIG. 2.

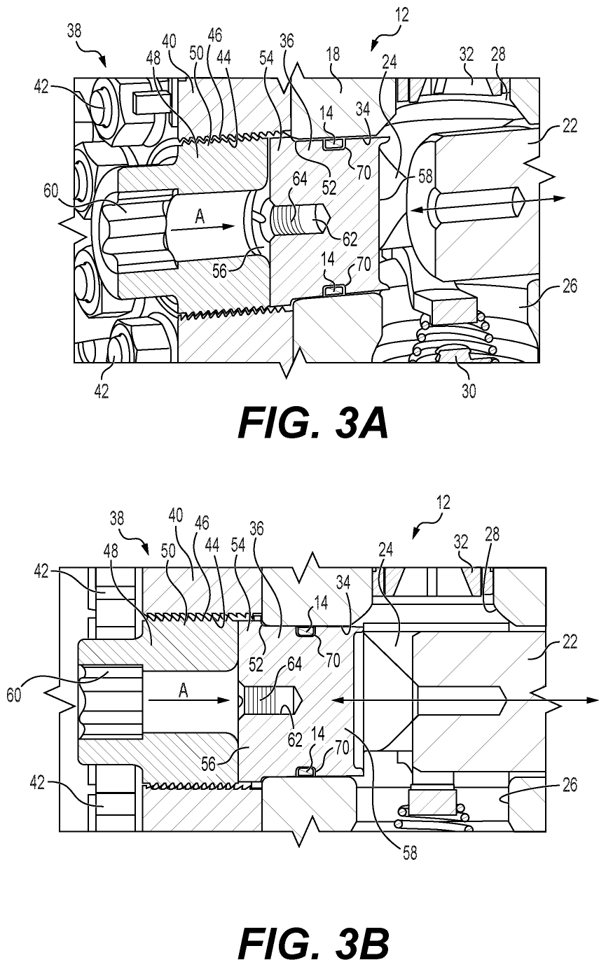

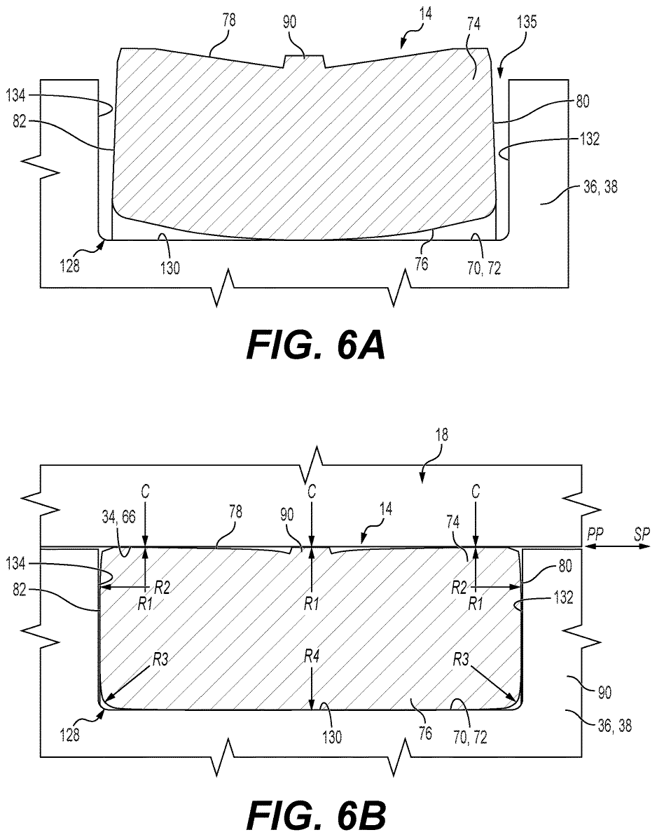

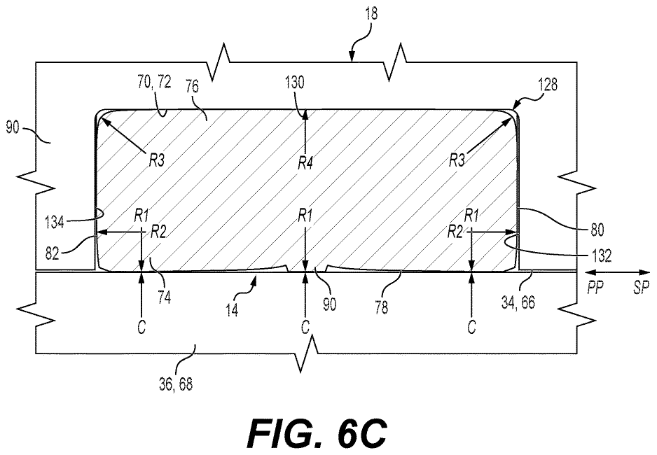

FIG. 3A is a schematic perspective view showing an example seal 14 and example components shown in FIG. 1, according to embodiments of the disclosure. FIG. 3B is a schematic side section view of the example seal 14 and example components shown in FIG. 3A, according to embodiments of the disclosure. As shown in FIGS. 3A and 3B, the example seal 14 may be provided between the interior surface of a first component (e.g., the access port 34) and an exterior surface of a second component (e.g., the cover 36), thereby to provide a fluid seal between the first and second components, for example, the access port 34 and the cover 36, when the cover 36 is placed in the access port 34. For example, as shown, the cover 36 may include on the outer cylindrical surface thereof an annular groove 70, and the seal 14 may be at least partially received in the groove 70. In some embodiments, the groove 70 may be provided in the interior surface of the access port 34 (e.g., an inner cylindrical surface), and the seal 14 may be at least partially received in the groove 70 in the interior surface of the access port 34 (see, e.g., FIG. 6C).

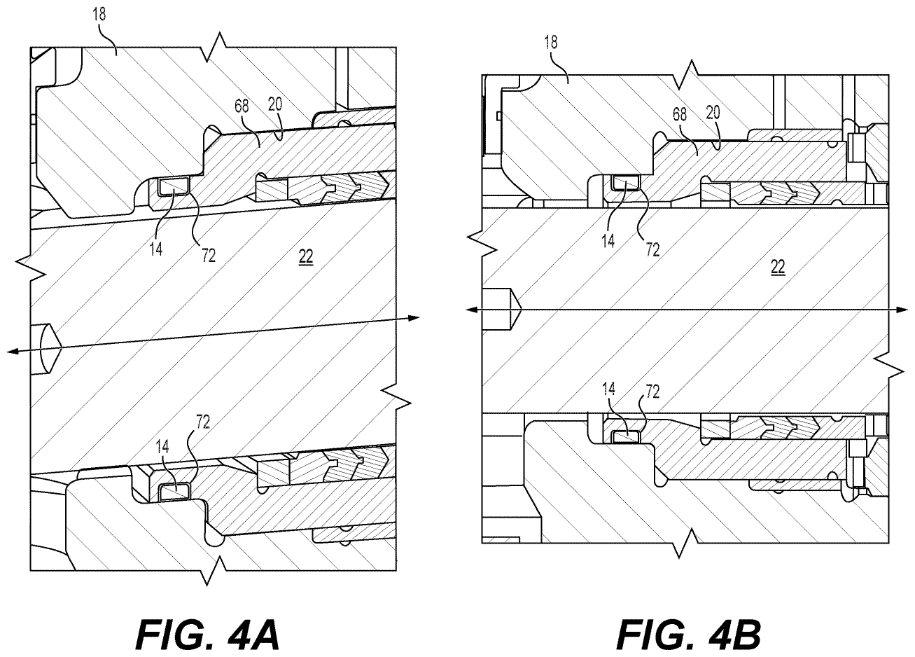

FIG. 4A is a schematic perspective view showing an example seal 14 and example components shown in FIG. 1, according to embodiments of the disclosure. FIG. 4B is a schematic side section view of the example seal 14 and example components shown in FIG. 4A, according to embodiments of the disclosure. As shown in FIGS. 4A and 4B, the example seal 14 may be provided between the interior surface of a first component (e.g., the plunger port 66) and an exterior surface of a second component (e.g., the sleeve 68), thereby to provide a fluid seal between the first and second components, for example, the plunger port 66 and the sleeve 68, when the sleeve 68 is placed in the plunger port 66. For example, as shown, the sleeve 68 may include on the outer cylindrical surface thereof an annular groove 72, and the seal 14 may be at least partially received in the groove 72. In some embodiments, the groove 72 may be provided in the interior surface of the plunger port 66 (e.g., an inner cylindrical surface), and the seal 14 may be at least partially received in the groove 72 in the interior surface of the plunger port 66 (see, e.g., FIG. 6C).

In some embodiments, the groove 70 and/or the groove 72 may be provided in the cover, in the sleeve, and/or in the port, for example, to help anchor the seal 14 relative to the corresponding cover 36 or the corresponding sleeve 68, and the seal 14 may be at least partially received in the corresponding groove. Some types of pumps, as noted above, may experience relatively large fluctuations in pressure, which may cause the seal 14 to deflect or compress in the groove during the pressure fluctuations. Applicant has recognized that this may result in causing the seal 14 and/or the corresponding groove to degrade relatively more quickly, for example, as fluid pumped during operation of the pump may migrate into the groove between the deflected or compressed seal and the corresponding groove. The wear may be particularly pronounced, for example, depending on the contents of the fluid. For example, abrasive particles and/or corrosive fluids may accelerate the wear of the seal and/or the groove, potentially leading to shortened service lives of the seal and one or more of the components, as well as increased downtime, reducing the efficiency of operations using the pump.

In some embodiments, the systems, assemblies, apparatuses, and methods presented herein may provide a relatively enhanced fluid seal between pump components, such as seals and adjacent components, which may result in relatively reduced damage, deformation, wear, and/or leakage during operation of high-power pumps including the seals and components. For example, in some embodiments, seals and associated components may be configured to reduce or prevent damage, deformation, wear, and/or leakage of the seals and associated components during operation of a high-power pump.

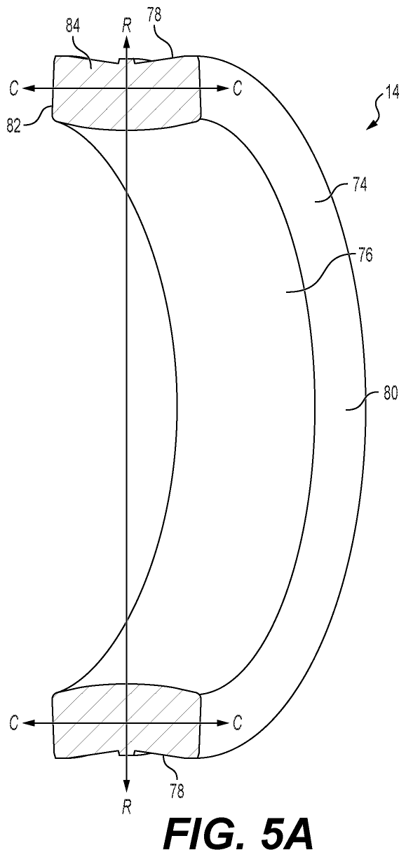

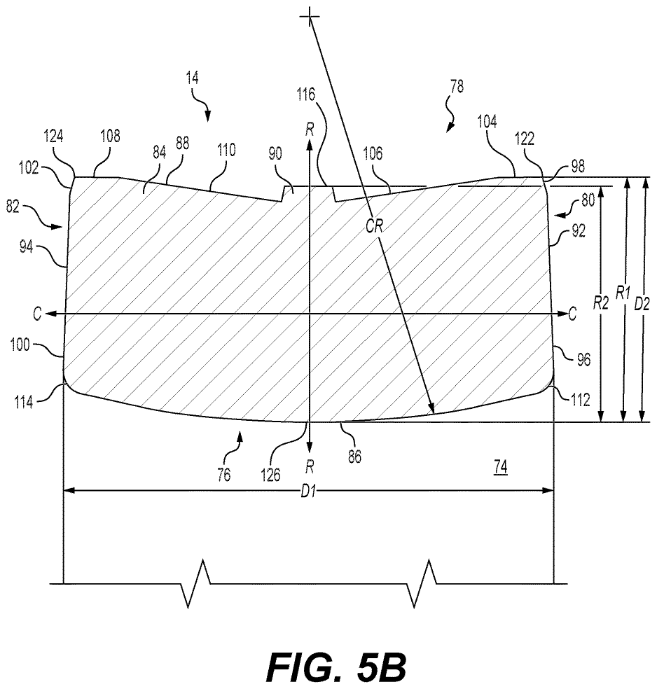

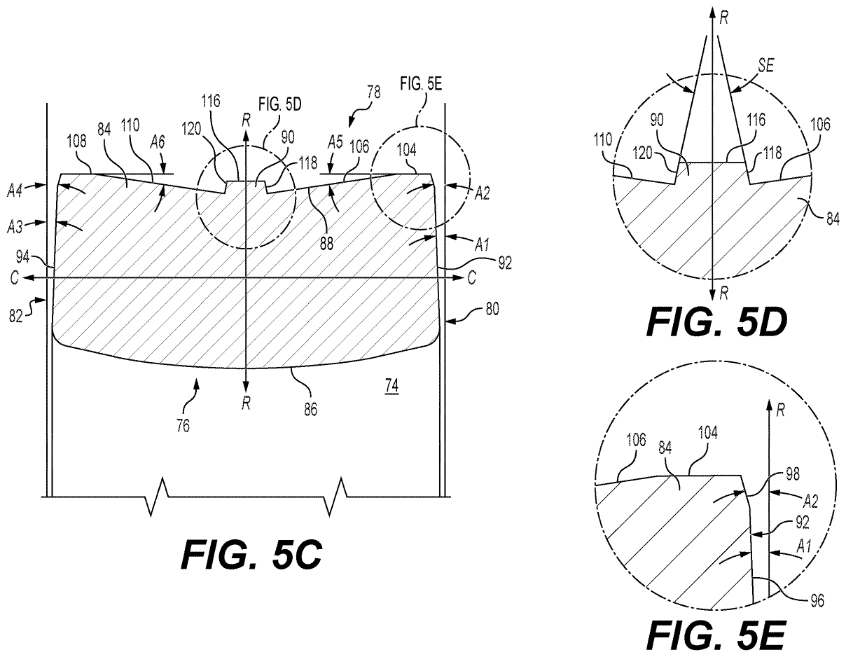

FIG. 5A is a schematic perspective section view of an example seal 14, according to embodiments of the disclosure. FIG. 5B is a schematic section view of the example seal 14 shown in FIG. 5A. FIG. 5C is a schematic section view of the example seal 14 shown in FIG. 5A. FIG. 5D is a schematic detailed section view of a portion of the example seal 14 shown in FIG. 5A, and FIG. 5E is a schematic detailed section view of another portion of the example seal 14 shown in FIG. 5A, according to embodiments of the disclosure.

As shown in FIGS. 5A and 5B, in some embodiments, the seal 14 may include an annular seal body 74. The annular seal body 74 may be formed from (or include) any compressible, resilient, and/or elastomeric materials, such as, for example, synthetic rubber, natural rubber, thermosetting polymers, and/or thermoplastic polymers, including, but not limited to: butadiene rubber (BR), butyl rubber (IIR), chlorosulfonated polyethylene (CSM), epichlorohydrin (ECH), ethylene propylene diene monomer (EPDM), ethylene propylene rubber (EPR), fluoroelastomer (FKM), nitrile rubber (NBR), perfluoroelastomer (FFKM), polyacrylate rubber (ACM), polychloroprene (neoprene), polyisoprene (IR), polysulfide rubber (PSR), polytetrafluoroethylene (PTFE), sanifluor (FEPM), silicone rubber (SiR), styrene-butadiene rubber (SBR), thermoplastic elastomer (TPE) styrenics, thermoplastic polyolefin (TPO), thermoplastic polyurethane (TPU), thermoplastic etheresterelastomer (TEEE) copolyester, thermoplastic polyamide (PEBA), melt-processible rubber (MPR), and/or thermoplastic vulcanizate (TPV).

In some embodiments, the annular seal body 74 may have a groove face 76 positioned to face a groove of one of two components between which a fluid seal is to be provided. For example, as described above, the cover 36 may include an annular groove 70 and/or the sleeve 68 may include an annular groove 72, and the seal 14 may be configured to be at least partially received in the annular groove 70 or the annular groove 72, for example, with the groove face 76 facing the bottom of the corresponding annular groove. In some embodiments, the access port 34 may include the annular groove 70 and/or the plunger port 66 may include the annular groove 72, and the groove face 76 may face the bottom of the corresponding annular groove (see, e.g., FIG. 6C).

As shown in FIGS. 5A and 5B, the seal body 74 further may have a sealing face 78 opposite the groove face 76 and positioned to face away from the groove face 76. In some embodiments, the sealing face 78 may be configured to press against the component of the two components between which the fluid seal is to be provided. For example, if the annular groove 70 is in the cover 36, the sealing face 78 may be configured to press against the interior surface of the access port 34. If the annular groove 70 is in the interior surface of the access port 34, the sealing face 78 may be configured to press against the outer surface of the cover 36. If the annular groove 72 is in the sleeve 68, the sealing face 78 may be configured to press against the interior surface of the plunger port 66. If the annular groove 72 is in the interior surface of the plunger port 66, the sealing face 78 may be configured to press against the outer surface of the sleeve 68.

As shown in FIGS. 5A and 5B, in some embodiments, the seal body 74 further may have a first lateral face 80 extending between the groove face 76 and the sealing face 78, and a second lateral face 82 opposite the first lateral face 80 and extending between the groove face 76 and the sealing face 78. The first lateral face 76 and the second lateral face 78 may be configured to press laterally outward against walls (e.g., side walls) of the annular groove 70 or the annular groove 72, for example, as described herein.

The seal body 74 may have a seal cross-section 84 (see, e.g., FIG. 5B) at least partially defined by the groove face 76, the sealing face 78, the first lateral face 80, and the second lateral face 82. The seal cross-section 84 may be a cross-section of the seal 14 viewed substantially perpendicular to a radial plane extending between the center of the seal 14 (e.g., the center of the annular seal body 74) and the radially outermost exterior surface of the seal. The radial plane may define a radial axis R, which may lie within the radial plane.

As shown in FIGS. 5A and 5B, the seal cross-section 84 may have a groove edge 86 at least partially defined by the groove face 76. In some embodiments, the groove edge 86 may be at least partially convex, for example, as shown. The seal cross-section 84 further may include a sealing edge 88 at least partially defined by the sealing face 78. The sealing edge 88 may be at least partially concave and may have, in some embodiments, a protrusion 90 between the first lateral face 80 and the second lateral face 82, for example, as shown in FIG. 5 A and 5B. The seal cross-section 84 further may have a first lateral edge 92 at least partially defined by the first lateral face 80, and a second lateral edge 94 at least partially defined by the second lateral face 82. As described herein, in some embodiments, the first lateral edge 92 and the second lateral edge 94 may include at least portions that are oblique with respect to one another, for example, as shown in FIGS. 5C and 5E.

As described herein, in some embodiments, the groove face 76, the sealing face 78, the first lateral face 80, and/or the second lateral face 82 may be positioned or configured to cause the seal 14 to deform in the annular groove 70 or the annular groove 72 of one of the two components when the other of the two components presses against the protrusion 90 in a direction toward the groove face 76, thereby to expand the seal body 74 laterally outward from the first lateral face 80 and the second lateral face 82, thereby to enhance the fluid seal between the first component and the second component.

As shown in in FIGS. 5C, 5D, and 5E, in some embodiments, the seal cross-section 84 may at least partially define the radial axis R extending between the groove edge 86 and the sealing edge 88 and a circumferential axis C extending between the first lateral edge 92 and the second lateral edge 94. In some embodiments, the circumferential axis C may be at least partially defined as an axis lying in a circumferential plane perpendicular to the radial axis R and extending through the seal cross-section 84, for example, at a radial center of the seal cross-section 84. Thus, in some embodiments, the radial axis R and the circumferential axis C may be substantially perpendicular relative to one another.

In some embodiments, the first lateral edge 92 and/or the second lateral edge 94 may extend obliquely with respect to the radial axis R, for example, such that the first lateral edge 92 and the second lateral edge 94 are closer to one another at the groove edge 86 than at the sealing edge 88, for example, as shown in FIGS. 5B and 5C. In some embodiments, the seal cross-section 84 may have bilateral symmetry with respect to the radial axis R, for example, as shown in FIGS. 5B and 5C.

As shown in FIG. 5B, the groove edge 86 may at least partially define a convex radius CR between the first lateral edge 92 and the second lateral edge 94. In some embodiments, the groove edge 86 may at least partially define a substantially continuous radius between the first lateral edge 92 and the second lateral edge 94. The groove edge 86 may at least partially define a substantially constant radius between the first lateral edge 92 and the second lateral edge 94.

As shown in FIGS. 5B and 5E, in some embodiments, the first lateral edge 92 may at least partially define a groove end portion 96 adjacent the groove edge 86, and a sealing end portion 98 adjacent the sealing edge 88. The groove end portion 96 and the sealing end portion 98 may be non-colinear, for example, as shown in FIGS. 5B and 5E. In some embodiments, the groove end portion 96 and the sealing end portion 98 may extend obliquely with respect to the radial axis R.

In some embodiments, the groove end portion 96 may extend in a first direction forming a first angle A1 with the radial axis R, and the sealing end portion 98 may extend in a second direction forming a second angle A2 with the radial axis R, with the second angle A2 being different than the first angle A1. For example, the first angle A1 may be less than the second angle A2, for example, as shown in FIG. 5E. For example, the first angle A1 may range from about 1 degree to about 10 degrees, and the second angle A2 may range from about 5 degrees to about 25 degrees.

In some embodiments, as shown in FIG. 5B, the second lateral edge 94 may at least partially define a groove end portion 100 adjacent the groove edge 86, and a sealing end portion 102 adjacent the sealing edge 88. The groove end portion 100 and the sealing end portion 102 may be non-colinear, for example, as shown in FIGS. 5B and 5C. In some embodiments, the groove end portion 100 and the sealing end portion 102 may extend obliquely with respect to the radial axis R.

In some embodiments, as shown in FIG. 5C, the groove end portion 100 may extend in a third direction forming a third angle A3 with the radial axis R, and the sealing end portion 102 may extend in a fourth direction forming a fourth angle A4 with the radial axis R, with the fourth angle A4 being different than the third angle A3. For example, the third angle A3 may be less than the fourth angle A4, for example, as shown in FIG. 5C. For example, the third angle A3 may range from about 1 degree to about 10 degrees, and the fourth angle A4 may range from about 5 degrees to about 25 degrees.

As shown in FIGS. 5C and 5E, in some embodiments, the sealing edge 88 may at least partially define a first lateral sealing edge portion 104 adjacent the first lateral edge 92, and a first intermediate sealing edge portion 106 adjacent the protrusion 90. The first lateral sealing edge portion 102 and the first intermediate sealing edge portion 106 may be non-colinear. In some embodiments, the first lateral sealing edge portion 104 may be substantially parallel to the circumferential axis C, for example, as shown in FIG. 5C. The first intermediate sealing edge portion 106 may form a fifth angle A5 ranging from about 1 degree to about 20 degrees with respect to the circumferential axis C, for example, as shown in FIG. 5C.

As shown in FIG. 5C, in some embodiments, the sealing edge 88 may at least partially define a second lateral sealing edge portion 108 adjacent the second lateral edge 94, and a second intermediate sealing edge portion 110 adjacent the protrusion 90. The second lateral sealing edge portion 108 and the second intermediate sealing edge portion 110 may be non-colinear. In some embodiments, the second lateral sealing edge portion 108 may be substantially parallel to the circumferential axis C, for example, as shown in FIG. 5C. The second intermediate sealing edge portion 110 may form a sixth angle A6 ranging from about 1 degree to about 20 degrees with respect to the circumferential axis C, for example, as shown in FIG. 5C. In some embodiments, the sealing edge 88 may include a first sealing edge segment extending between the first lateral edge 92 and the protrusion 90, and a second sealing edge segment extending between the second lateral edge 94 and the protrusion 90, for example, as shown in FIG. 5C. The first sealing edge segment may include one or more of the first lateral sealing edge portion 104 or the first intermediate sealing edge portion 106, and the second sealing edge segment may include one or more of the second lateral sealing edge portion 108 or the second intermediate sealing edge portion 110.

As shown in FIG. 5B, in some embodiments, the seal cross-section 84 may have a first rounded transition 112 between the groove edge 86 and the first lateral edge 92, and a second rounded transition 114 between the groove edge 86 and the second lateral edge 94. The first rounded transition 112 may have a first transition radius, and the second rounded transition 114 may have a second transition radius. The groove edge 86 may at least partially define a convex radius CR between the first lateral edge 92 and the second lateral edge 94, and the convex radius CR may be greater than one or more of the first transition radius or the second transition radius, for example, as shown in FIG. 5B. In some embodiments, the first transition radius may be substantially equal to the second transition radius. As shown in FIGS. 5B and 5C, the protrusion 90 may be substantially equidistant from the first lateral edge 92 and the second lateral edge 94.

In some embodiments, the protrusion 90 may extend away from the first intermediate sealing edge portion 106 and/or the second intermediate sealing edge portion 110. For example, as shown in FIG. 5D, the protrusion 90 may include a protrusion apex 116 remote from the first intermediate sealing edge portion 106 and/or the second intermediate sealing edge portion 110. The protrusion 90 further may include a first side edge 118 adjacent the first intermediate sealing edge portion 106 and extending to the protrusion apex 116, and a second side edge 120 adjacent the second intermediate sealing edge portion 110 and extending to the protrusion apex 116. In some embodiments, the first side edge 118 and the second side edge 120 may be oblique with respect to one another, for example, as shown in FIGS. 5C and 5D. For example, the first side edge 118 and the second side edge 120 may form a side edge angle SE therebetween ranging from about 5 degrees to about 60 degrees. In some embodiments, the first side edge 118 and/or the second side edge 120 may be oblique with respect to the radial axis R. For example, the radial axis R and the first side edge 118 and/or the second side edge 120 may at least partially define an axis-to-side edge angle therebetween ranging from about 1 degree to about 30 degrees. As shown in FIGS. 5C and 5D, the apex 116 may be substantially flat.

As shown in FIG. 5B, in some embodiments, the first lateral edge 92 and the second lateral edge 94 may at least partially define a first cross-section dimension D1 perpendicular to the radial axis R, and the groove edge 86 and the sealing edge 88 may at least partially define a second cross-section dimension D2 parallel to the radial axis R. In some embodiments, a ratio of the first cross-section dimension D1 to the second cross-section dimension D2 may range from about 1:1 to about 3.5:1. In some embodiments, a ratio of the groove edge radius CR to the first cross-section dimension D1 may range from about 3:1 to about 1.1:1.

In some embodiments, as shown in FIG. 5B, the first lateral edge 92 and the sealing edge 88 may meet at a first sealing edge intersection 122, and the second lateral edge 94 and the sealing edge 88 may meet at a second sealing edge intersection 124. The groove edge 86 may at least partially define a groove edge apex 126, and the protrusion 90 may at least partially define the protrusion apex 116. As shown in FIG. 5C, in some embodiments, one or more of: (a) the first sealing edge intersection 122 and the groove edge apex 126, or (b) the second sealing edge intersection 124 and the groove edge apex 126 may at least partially define a first radial dimension R1. The groove edge apex 126 and the protrusion apex 116 may at least partially define a second radial dimension R2. In some embodiments, a ratio of the first radial dimension R1 to the second radial dimension R2 may range from about 1:1 to about 1.4:1.

FIG. 6A is a schematic section view of the example seal 14 shown in FIG. 5A in an uncompressed condition received in an example groove 70 of an example first component (e.g., a cover 36 or a sleeve 68), according to embodiments of the disclosure. FIG. 6B is a schematic section view of the example seal 14 shown in FIG. 5A in a deformed and activated condition when a second example component (e.g., an access port 34 or a plunger port 66 of a fluid end housing 18) compresses the seal 14 received in the example groove 70 or 72 of the example first component (e.g., in a substantially cylindrical outer surface of the first component), according to embodiments of the disclosure. FIG. 6C is a schematic section view of the example seal 14 shown in FIG. 5A in a deformed and activated condition when a second example component (e.g., a cover 36 or a sleeve 68) compresses the seal 14 received in the example groove 70 or 72 of an example first component (e.g., in a substantially cylindrical inner surface of the first component), according to embodiments of the disclosure.

As shown in FIGS. 6A, 6B, and 6C, the grooves 70 and/or 72 may have a groove cross-section 128. In some embodiments, the groove cross-section 128 may be at least partially defined by a groove bottom 130, a first groove side wall 132, and a second groove side wall 134 opposing the first groove side wall 132, thereby forming a substantially rectangular-shaped open-topped groove cross-section 128. Groove cross-sections 128 having other shapes are contemplated, such as, for example, groove cross-sections having rounded transitions between the groove bottom 130 and groove side walls 132 and/or 134, polygonal shapes other than rectangular, non-polygonal-shaped cross-sections, semi-circular cross-sections, and the like.

As shown in FIG. 6A, in some embodiments, when the seal 14 is in an uncompressed or unactivated state, the distance between the first groove side wall 132 and the second groove side wall 134 may be greater than the first dimension D1 (see FIG. 5B) between the outermost portions of the first lateral face 80 and the second lateral face 82 of the annular seal body 74. This may create a gap between the seal 14 and one or more of the first groove side wall 132 or the second groove side wall 134, for example, prior to assembly of a second component (e.g., the fluid end housing 18) relative to a first component (e.g., a cover 36 or a sleeve 38) including the groove 70 or 72 and the seal 14 in the groove 70 or 72.

In some embodiments of the seal 14, for example, as shown in FIG. 5B, the first lateral edge 92 and the sealing edge 88 meet at the first sealing edge intersection 122, and the second lateral edge 94 and the sealing edge 88 meet at the second sealing edge intersection 124. In some such embodiments, the groove edge 86 may at least partially define the groove edge apex 126, and the protrusion 90 may at least partially define the protrusion apex 116. The first sealing edge intersection 122 and the groove edge apex 126, and/or the second sealing edge intersection 124 and the groove edge apex 126, may at least partially define the first radial dimension R1. In some embodiments, the groove edge apex 126 and the protrusion apex 116 may at least partially define a second radial dimension R2. In some embodiments, the first radial dimension R1 may be greater than the second radial dimension R2, such that as a first one of the two components (e.g., an access port 34 or a plunger port 66) compresses the seal 14 at the first sealing edge intersection 122 and the second sealing edge intersection 124, the groove edge apex 126 causes the protrusion 90 to be compressed against the first one of the two components, thereby to preload the seal 14 and enhance the fluid seal between the two components, for example, as shown in FIGS. 6B and 6C.

As shown in FIGS. 6A and 6B, in some embodiments, one or more of the groove face 76, the sealing face 78, the first lateral face 80, or the second lateral face 82 may be positioned to cause the seal 14 to deform in the annular groove of the one of the first component or the second component when the other of the first component or the second component presses against the protrusion 90 in a direction toward the groove face 76, thereby to expand the annular seal body 74 laterally outward from the first lateral face 80 and the second lateral face 82 and preload the seal 14 in the annular groove, thereby to enhance the fluid seal between the first component and the second component, for example, as shown in FIGS. 6B and 6C. In some embodiments, the seal 14 may be activated via installation of the second component relative to the first component, which includes the annular groove receiving the seal 14, for example, as the second component is moved into position relative to the first component. In some embodiments, no additional tool may be necessary to install and activate the seal 14 relative to the first and second components. For example, the seal 14 may be manually (e.g., via hand) placed in the annular groove, and the seal 14 may be compressed and thereby activated, for example, as shown in FIGS. 6A-6C, via the second component, as the second component is moved into an installed position relative to the first component and the seal 14.

In some embodiments, the groove edge 86 and the sealing edge 88 may at least partially define a spring (e.g., a mono-leaf spring approximating a curved cross-section, for example, as shown in FIG. 6A), such that, in an uncompressed state, as a first one of the components compresses the seal 14, the groove face 76 causes the protrusion 90 to be pressed radially outward against the first component, thereby to preload the seal 14 and enhance the fluid seal between the first component and the second component, for example, as shown in FIGS. 6B and 6C.

In some embodiments, the seal cross-section 84 may at least partially define a seal cross-sectional area, and the groove edge 86 may at least partially define a convex radius between the first lateral edge 92 and the second lateral edge 94. The seal cross-sectional area and the convex radius may be selected to: (a) cause the seal 14 to expand laterally outward against side walls of the groove when a first one of the two components compresses the seal 14; and (b) press the protrusion 90 against the first one of the components when the first one of the components compresses the seal 14, thereby to enhance the fluid seal between the first component and the second component, for example, as shown in FIGS. 6B and 6C.

For example, as schematically shown in FIGS. 6B and 6C, the groove face 76, the sealing face 78, the first lateral face 80, and/or the second lateral face 82 may be configured to cause the seal 14 to deform in the annular groove 70 of a first component, for example, a cover 36 as shown (or a sleeve 38) when a second component, for example, an inner cylindrical surface of access port 34 as shown (or a plunger port 66) of the fluid end housing 18, presses against the protrusion 90 in a direction toward the groove face 76, thereby to expand the annular seal body 74 laterally outward from the first lateral face 80 and the second lateral face 82 and preload the seal 14 in the annular groove, thereby to enhance the fluid seal between the first component and the second component.

For example, as schematically depicted in FIG. 6B, as the cover 36 is inserted into the access port 34, the cylindrical inner surface of the access port 34 presses against the sealing face 78 in a direction toward the annular groove 70 of the cover 36, for example, as depicted by arrows C. For example, due to the generally concave profile of the sealing face 78, including the protrusion 90 and the edges of the sealing face 78 adjacent the first lateral face 80 and the second lateral face 82 providing leading annual edges of the sealing face 78 relative to the inner cylindrical surface of the access port 34, the protrusion 90 and the edges of the sealing face 78 adjacent the first lateral face 80 and the second lateral face 82 are compressed and deformed to a relatively greater extent than other portions of the sealing face 78, resulting in relatively greater reactive forces pressing outward toward the inner cylindrical surface of the access port 34, for example, as depicted by the arrows R1. This example activation of the seal 14 may result in enhancing the fluid seal between the cover 36 and access port 34 by creating a relatively tighter abutment of the sealing face 78 against the inner cylindrical surface of the access port 34, thereby reducing the likelihood or preventing fluid and/or particulates being pumped by the pump 10 from passing into the interface between the sealing face 78 and the inner cylindrical surface of the access port 34.

In addition, in some embodiments, as shown in FIG. 6B, the edges of the sealing face 78 adjacent the first lateral face 80 and the second lateral face 82, compressed and deformed to a relatively greater extent than other portions of the sealing face 78, press laterally outward from the first lateral face 80 adjacent the sealing face 78 and the second lateral face 82 adjacent the sealing face 78 of the seal 14, resulting in relatively greater reactive forces pressing outward, respectively, toward the first groove side wall 132 and the second groove side wall 134, for example, as depicted by the arrows R2. This example activation of the seal 14 may result in enhancing the fluid seal between (a) the first lateral face 80 adjacent the sealing face 78 and the first groove side wall 132, and (b) between the second lateral face 82 adjacent the sealing face 78 and the second groove side wall 134, for example, by creating a relatively tighter abutment of the first and second lateral faces 80 and 82 against the respective first and second groove side walls 132 and 134, thereby reducing the likelihood or preventing fluid and/or particulates being pumped by the pump 10 from passing into the interface between the first and second lateral faces 80 and 82 and the respective first and second groove side walls 132 and 134.

In addition, in some embodiments, for example, as shown in FIG. 5C, the groove face 76 may have a relatively greater lateral dimension (e.g., in the direction of the circumferential axis C) than the sealing face 78. In some embodiments, as shown in FIG. 6B, the relatively greater lateral dimension of the groove face 78 may result in the first lateral face 80 adjacent the groove face 76 and the second lateral face 82 adjacent the groove face 76 being compressed and deformed to a relatively greater extent, causing the first lateral face 80 adjacent the groove face 76 and the second lateral face 82 adjacent the groove face 76 to press laterally outward toward and/or into corners of the annular groove 70 between (a) the first groove side wall 132 and the groove bottom 130, and (b) the second groove side wall 134 and the groove bottom 130, for example, as depicted by the arrows R3. This example activation of the seal 14 may result in enhancing the fluid seal between (a) the first lateral face 80 adjacent the groove face 76 and the first groove side wall 132, and (b) the second lateral face 82 adjacent the groove face 76 and the second groove side wall 134, for example, by creating a relatively tighter abutment of the first and second lateral faces 80 and 82 against the respective first and second lateral groove side walls 132 and 134, thereby reducing the likelihood or preventing fluid and/or particulates being pumped by the pump 10 from passing into the interface between the first and second lateral faces 80 and 82 and the respective first and second lateral groove side walls 132 and 134.

In addition, in some embodiments, as shown in FIG. 6B, as the seal 14 is compressed and deformed into the annular groove 70 by the inner cylindrical surface of the access port 34, the convex groove face 76 of the annular seal body 74 is deformed and caused to flatten and substantially follow the profile of the groove bottom 130, thereby causing the groove face 76 of the seal 14 to press against the groove bottom 130, for example, as depicted by the arrow R4. This example activation of the seal 14 may result in enhancing the fluid seal between the seal 14 and the groove bottom 130 by creating a relatively tighter abutment of the groove face 76 against the groove bottom 130, thereby reducing the likelihood or preventing fluid and/or particulates being pumped by the pump 10 from passing into the interface between the groove face 76 and the inner the groove bottom 130.

In some embodiments, the example seal configurations may result in enhancing the fluid seal between the cover 36 (or sleeve 38) and the access port 34 (or plunger port 66), for example during operation of a pump 10 creating cyclic pressure and suction pulses. For example, as a plunger 22 of the pump 10 (see FIG. 2) moves in a first direction to increase the pressure of a fluid in the chamber 24 a high pressure pulse PP (see FIGS. 6B and 6C) forces fluid and/or particulates toward the seal 14 between the outer surface of the cover 36 and the inner surface of the access port 34, for example, as depicted by arrow PP in FIGS. 6B and 6C. In some embodiments, the seal 14 may provide enhanced resistance to the pressure pulse PP. As the plunger 22 of the pump 10 (see FIG. 2) moves in a second direction opposite the first direction a suction pulse SP (see FIGS. 6B and 6C) is created. In some embodiments, the seal 14 may provide enhanced resistance to the suction pulse SP and/or against the cyclic pressure change.

Thus, in some embodiments, the configuration of the seal 14 may result in providing a relatively enhanced fluid seal between pump components, such as the seals 14 and adjacent components, which may result in relatively reduced damage, deformation, wear, and/or leakage during operation of high-power pumps including the seals 14 and components. For example, in some embodiments, the seals 14 and associated components may be configured to reduce or prevent damage, deformation, wear, and/or leakage of the seals 14 and associated components during operation of the high-power pumps. For example, for some types of pumps that may experience relatively large fluctuations in pressure, some embodiments of the seal 14 may reduce or prevent deflection of the seal 14 during pressure fluctuations. This, in turn, may reduce the likelihood or prevent fluid, particles, and/or debris from migrating between the seal 14 and an associated groove in which the seal 14 is at least partially received and/or any related components. This may reduce wear of the seal 14 and/or the associated components, for example, even when the fluid includes caustic materials and/or abrasive particles. As a result, according to some embodiments, the seal 14 may provide relatively reduced wear rates and lengthened service lives of the seal 14 and associated components, as well as decreased downtime, increasing the efficiency of operations using the pump.

As schematically depicted in FIG. 6C, the example first component may be a fluid end housing 18 having an access port 34 or a plunger port 66 with an annular groove 70 or 72 in a substantially cylindrical inner surface of the fluid end housing 18. The example second component may be a cover 36 for closing the access port 34 received in the access port 34 or a sleeve 68 received in the plunger port 66.

In at least some embodiments consistent with FIG. 6C, as the cover 36 is inserted into the access port 34, for example, the cylindrical outer surface of the cover 36 presses against the sealing face 78 in a direction toward the annular groove 70 of the access port 34, for example, as depicted by arrows C. For example, due to the generally concave profile of the sealing face 78, including the protrusion 90 and the edges of the sealing face 78 adjacent the first lateral face 80 and the second lateral face 82 providing leading annular edges of the sealing face 78 relative to the outer cylindrical surface of the cover 36, the protrusion 90 and the edges of the sealing face 78 adjacent the first lateral face 80 and the second lateral face 82 are compressed and deformed to a relatively greater extent than other portions of the sealing face 78, resulting in relatively greater reactive forces pressing outward toward the outer cylindrical surface of the cover 36 or sleeve 68, for example, as depicted by the arrows R1. This example activation of the seal 14 may result in enhancing the fluid seal between the cover 36 and access port 34 by creating a relatively tighter abutment of the sealing face 78 against the outer cylindrical surface of the cover 36, thereby reducing the likelihood or preventing fluid and/or particulates being pumped by the pump 10 from passing into the interface between the sealing face 78 and the outer cylindrical surface of the cover 36.

In addition, in some embodiments, as shown in FIG. 6C, the edges of the sealing face 78 adjacent the first lateral face 80 and the second lateral face 82, compressed and deformed to a relatively greater extent than other portions of the sealing face 78, press laterally outward from the first lateral face 80 adjacent the sealing face 78 and the second lateral face 82 adjacent the sealing face 78 of the seal 14, resulting in relatively greater reactive forces pressing outward, respectively, toward the first groove side wall 132 and the second groove side wall 134, for example, as depicted by the arrows R2. This example activation of the seal 14 may result in enhancing the fluid seal between (a) the first lateral face 80 adjacent the sealing face 78 and the first groove side wall 132, and (b) between the second lateral face 82 adjacent the sealing face 78 and the second groove side wall 134, for example, by creating a relatively tighter abutment of the first and second lateral faces 80 and 82 against the respective first and second groove side walls 132 and 134, thereby reducing the likelihood or preventing fluid and/or particulates being pumped by the pump 10 from passing into the interface between the first and second lateral faces 80 and 82 and the respective first and second groove side walls 132 and 134.

In addition, in some embodiments, for example, as shown in FIG. 5C, the groove face 76 may have a relatively greater lateral dimension (e.g., in the direction of the circumferential axis C) than the sealing groove 78. In some embodiments, as shown in FIG. 6C, the relatively greater lateral dimension of the groove face 78 may result in the first lateral face 80 adjacent the groove face 76 and the second lateral face 82 adjacent the groove face 76 being compressed and deformed to a relatively greater extent, causing the first lateral face 80 adjacent the groove face 76 and the second lateral face 82 adjacent the groove face 76 to press laterally outward toward and/or into corners of the annular groove 70 between (a) the first groove side wall 132 and the groove bottom 130, and (b) the second groove side wall 134 and the groove bottom 130, for example, as depicted by the arrows R3. This example activation of the seal 14 may result in enhancing the fluid seal between (a) the first lateral face 80 adjacent the groove face 76 and the first groove side wall 132, and (b) the second lateral face 82 adjacent the groove face 76 and the second groove side wall 134, for example, by creating a relatively tighter abutment of the first and second lateral faces 80 and 82 against the respective first and second lateral groove side walls 132 and 134, thereby reducing the likelihood or preventing fluid and/or particulates being pumped by the pump 10 from passing into the interface between the first and second lateral faces 80 and 82 and the respective first and second lateral groove side walls 132 and 134.

In addition, in some embodiments, as shown in FIG. 6C, as the seal 14 is compressed and deformed into the annular groove 70 or 72 by the outer cylindrical surface of the cover 36 or sleeve 68, the convex groove face 76 of the annular seal body 74 may be deformed and caused to flatten and substantially follow the profile of the groove bottom 130, thereby causing the groove face 76 of the seal 14 to press against the groove bottom 130, for example, as depicted by the arrow R4. This example activation of the seal 14 may result in enhancing the fluid seal between the seal 14 and the groove bottom 130 by creating a relatively tighter abutment of the groove face 76 against the groove bottom 130, thereby reducing the likelihood or preventing fluid and/or particulates being pumped by the pump 10 from passing into the interface between the groove face 76 and the groove bottom 130.

In some embodiments, the example seal configurations may result in enhancing the fluid seal between the cover 36 (or sleeve 68) and the access port 34 (or plunger port 66), for example, during operation of the pump 10 creating cyclic pressure pulses and suction pulses. For example, as a plunger 22 of the pump 10 (see FIG. 2) moves in a first direction B to increase the pressure of a fluid in the chamber 24 a high pressure pulse PP (see FIG. 6C) forces fluid and/or particulates toward the seal 14 between the outer surface of the cover 36 and the inner surface of the access port 34, for example, as depicted by arrow PP in FIG. 6C. In some embodiments, the seal 14 may provide enhanced resistance to the pressure pulse PP. As the plunger 22 of the pump 10 (see FIG. 2) moves in a second direction A opposite the first direction B, a suction pulse SP is created. In some embodiments, the seal 14 may provide enhanced resistance to the suction pulse SP and/or against the cyclic pressure change. Thus, in some embodiments, the configuration of the seal 14 may result in providing a relatively enhanced fluid seal between pump components, such as the seals 14 and adjacent components, which may result in relatively reduced damage, deformation, wear, and/or leakage during operation of high-power pumps including the seals 14 and components. For example, in some embodiments, the seals 14 and associated components may be configured to reduce or prevent damage, deformation, wear, and/or leakage of the seals 14 and associated components during operation of the high-power pumps.

In some embodiments, a method to enhance a fluid seal between two components of the pump 10, such as, for example, between a cover and an access port or between a sleeve and a cylinder, may include inserting the 14 seal into an annular groove (e.g., an annular groove 70 or 72) of a first component of the pump 10 (e.g., a fluid end housing). The seal 14 may include a groove face 76 and a sealing face 78 opposite the groove face 76. According to some embodiments, the groove face 76, in an undeformed condition, may be substantially convex, and the sealing face 78, in the undeformed condition, may be substantially concave, for example, as shown in FIG. 6A. As shown in FIGS. 6A and 6B, the annular groove may have a groove cross-section 128 at least partially defined by a bottom 130 of the annular groove, a first side wall 132, a second side wall 134 opposite the first side wall 132, and an open portion 135 of the annular groove 70 opposite the bottom 130 and extending between the first side wall 132 and the second side wall 134. Inserting the seal 14 into the annular groove may result in at least a portion of the groove face 76 of the seal 14 contacting the bottom 130 of the annular groove and at least a portion of sealing face 78 of the seal 14 protruding beyond the open portion 135 of the annular groove, for example, as shown in FIG. 6A. The method further may include assembling a second component of the pump 10 relative to the first component of the pump 10 (e.g., a fluid end housing relative to a cover or a sleeve). The method further may include compressing, via the second component, so as to deform the seal 14 when positioned in the annular groove, thereby to cause the groove face 76 to abut and substantially fill the bottom 130 of the annular groove and extend from the first side wall 132 to the second side wall 134, so as to enhance the fluid seal between the first component and the second component, for example, as shown in FIGS. 6B and 6C.

In some embodiments of the method, assembling the two components relative to one another may include assembling the second component of the pump 10 relative to the first component of the pump 10, thereby to press the second component against the sealing face 78 in a direction toward the groove face 76, thereby to substantially flatten the sealing face 78 and preload the seal 14 in the annular groove, thereby to enhance the fluid seal between the first component and the second component. As described herein, in some embodiments, the sealing face 78 may include a protrusion 90, and assembling components may include pressing the protrusion 90 via the second component in a direction toward the groove face 76 and expanding the seal 14 laterally outward to preload the seal 14 in the annular groove, thereby to enhance the fluid seal between the first component and the second component. In some embodiments, as described herein, the first lateral face 80 and the second lateral face 82, in the undeformed condition, may extend obliquely relative to one another. In at last some such embodiments, assembling the two components may include deforming the seal 14 in the annular groove, so that the first lateral face 80 presses against and substantially conforms to the first side wall 132 of the annular groove and the second lateral face 82 presses against and substantially conforms to the second side wall 134 of the annular groove, thereby to enhance the fluid seal between the first component and the second component.

In some embodiments, inserting the seal 14 into the annular groove may include inserting the seal 14 into the annular groove in a substantially cylindrical outer surface of a first one of the two components. In at least some such embodiments, assembling the two components may include sliding a second one of the two components over the substantially cylindrical outer surface of the first one of the components and the seal 14, thereby to deform and compress the seal 14 in the annular groove, thereby activating the seal in the annular groove. In some embodiments, inserting the seal 14 into the annular groove may include inserting the seal 14 into the annular groove in a substantially cylindrical outer surface of one of (a) a cover configured to fit in a port or (b) a sleeve configured to fit into a cylinder. In some embodiments, inserting the seal 14 into the annular groove may include inserting the seal 14 into the annular groove in a substantially cylindrical inner surface of a first one of the two components, for example, as shown in FIG. 6C. In at least some such embodiments, assembling the two components may include sliding the second of the two components into the substantially cylindrical inner surface of the first component, thereby to compress and deform the annular seal in the annular groove. In some embodiments, inserting the seal 14 into the annular groove may include inserting the seal 14 into the annular groove in a substantially cylindrical inner surface of one of (a) a port configured to receive therein a cover or (b) a cylinder configured to receive therein a sleeve.

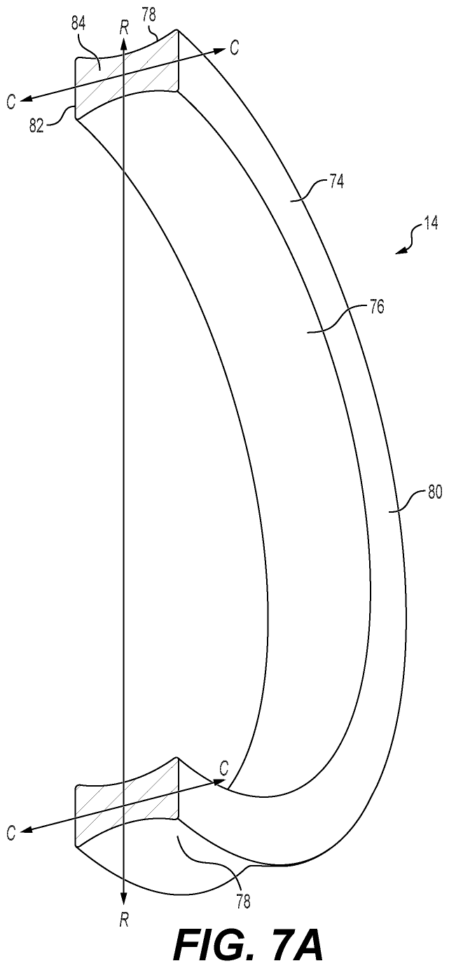

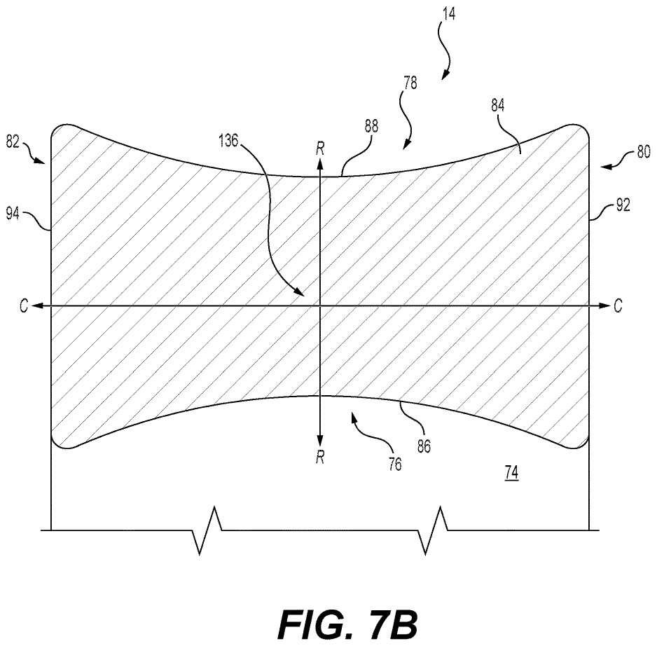

FIG. 7A is a schematic perspective section view of another example seal 14 to enhance a fluid seal between an outer surface of a first component having a substantially circular cross-section and an inner surface of a second component, according to embodiments of the disclosure, and FIG. 7B is a schematic section view of the example seal 14 shown in FIG. 7A in an uncompressed condition. As shown in FIGS. 7A and 7B, the annular seal body 74 may have a seal cross-section 84 at least partially defined by a groove face 76, a sealing face 78, a first lateral face 80, and a second lateral face 82. As shown, in some embodiments, the seal cross-section 84 may have a groove edge 86 at least partially defined by the groove face 76, and the groove edge 86 may be at least partially concave. The seal cross-section 84 further may have a sealing edge 88 at least partially defined by the sealing face 80, and the sealing edge 88 may be at least partially concave. The seal cross-section 84 also may have a first lateral edge 92 at least partially defined by the first lateral face 80, and a second lateral edge 94 at least partially defined by the second lateral face 82. The groove edge 86 and the sealing edge 88 may form an area 136 between the first lateral edge 92 and the second lateral edge 94 having a relatively reduced thickness, for example, as compared to the thickness of the annular seal body 74 at the first and second lateral edges 92 and 94. In some embodiments, the groove face 76, the sealing face 78, the first lateral face 80, and/or the second lateral face 82 may be positioned to cause the seal 14 to deform in the groove of the first component or the second component when the other of the first component or the second component presses against the sealing face 78 in a direction toward the groove face 76, thereby to compress and deform the area 136 between the first lateral edge 92 and the second lateral edge 94 and expand the annular seal body 74 laterally outward from the first lateral face 80 and the second lateral face 82, thereby to enhance the fluid seal between the first component and the second component. In some embodiments consistent with FIGS. 7A and 7B, the area 136 may have a reduced thickness relative to other portions of the seal 14, and the area 136 may result in relatively reduced stiffness, which may facilitate a relatively increased level of compression, thereby enhancing the fluid seal between the first component and the second component.

As shown in FIGS. 7A and 7B, in some embodiments, the first lateral edge 92 and/or the second lateral edge 94 may be substantially planar. In some embodiments, the first lateral edge 92 and the second lateral edge 94 may be substantially parallel to one another. As shown, in some embodiments, the first lateral edge 92 and/or the second lateral edge 94 may be substantially parallel to the radial axis R of the seal 14. In some embodiments, the seal cross-section 84 may have bilateral symmetry relative to a radial axis R of the seal 14. In some embodiments, for example, as shown in FIGS. 7A and 7B, the seal cross-section may have bilateral symmetry relative to the circumferential axis C of the seal 14.

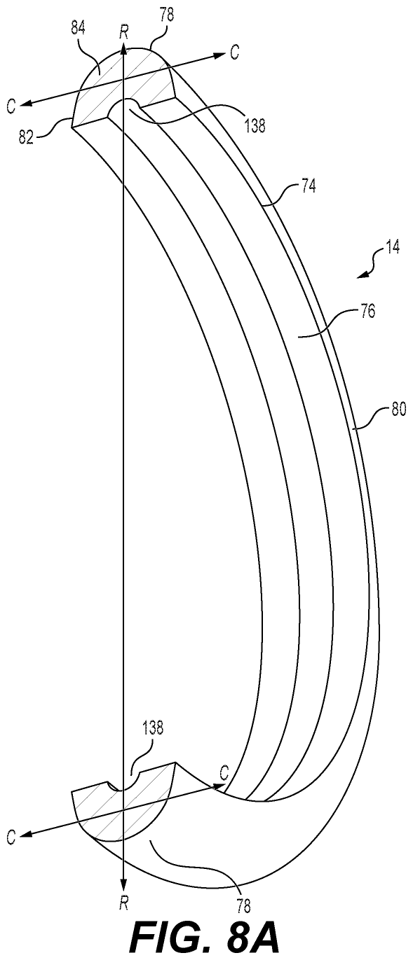

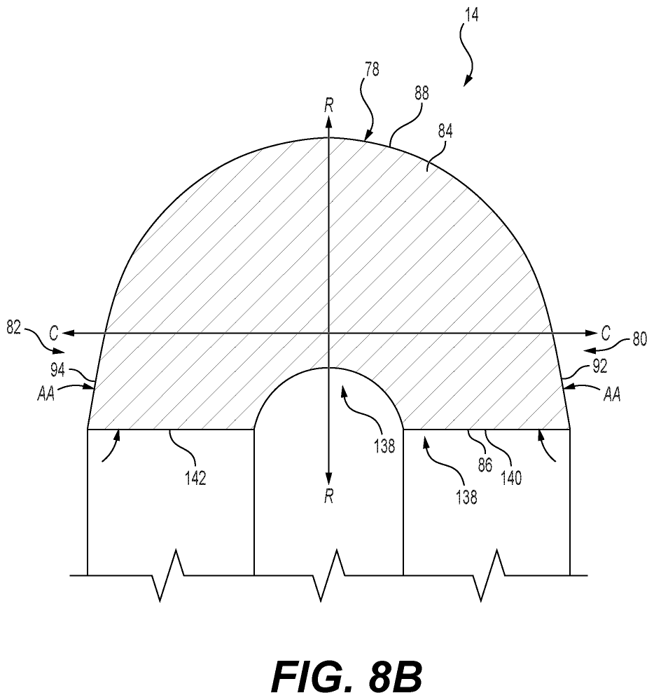

FIG. 8A is a schematic perspective section view of another example seal 14 to enhance a fluid seal between an outer surface of a first component having a substantially circular cross-section and an inner surface of a second component, according to embodiments of the disclosure, and FIG. 8B is a schematic section view of the example seal 14 shown in FIG. 8A in an uncompressed condition. As shown in FIGS. 8A and 8B, the annular seal body 74 may have a seal cross-section 84 at least partially defined by a groove face 76, a sealing face 78, a first lateral face 80, and a second lateral face 82. The seal cross-section 84, in some embodiments, may have a groove edge 86 at least partially defined by the groove face 76, and the groove edge 86 may at least partially define a groove recess 138, for example, as shown in FIGS. 8A and 8B. The seal cross-section 84 further may have a sealing edge 88 at least partially defined by the sealing face 78, and the sealing edge 88 may be at least partially convex. The seal cross-section 84 also may have a first lateral edge 92 at least partially defined by the first lateral face 80, and a second lateral edge 94 at least partially defined by the second lateral face 82. In some embodiments, as shown in FIGS. 8A and 8B, the first lateral edge 92, the sealing edge 88, and the second lateral edge 94 may at least partially define a substantially continuous arc. In some embodiments, the groove face 76, the sealing face 78, the first lateral face 80, or the second lateral face 82 may be positioned to cause the seal 14 to compress and deform in the groove of the first component or the second component when the other of the first component or the second component presses against the sealing face 78 in a direction toward the groove face 76, thereby to push an area 136 of the seal between the first lateral edge 92 and the second lateral edge 94 against the other of the first component or the second component and expand the annular seal body 74 laterally outward from the first lateral face 80 and the second lateral face 82 and press against walls of the groove, thereby to enhance the fluid seal between the first component and the second component.

In some embodiments consistent with FIGS. 8A and 8B, the groove recess 138 may render an area of the seal 14 between the first lateral face 80 and the second lateral face 82 relatively more flexible than other portions of the seal 14. This, in turn, may cause the first and second lateral faces 80 and 82 to expand laterally outward against the groove bottom 130 and/or the groove side walls 132 and 134 (see, e.g., the example annular groove 70 shown in FIGS. 6A-6C). This may result in enhancing the fluid seal between the first component and the second component.

As shown in FIGS. 8A and 8B, in some embodiments, the sealing edge 88 may be substantially semi-circular. In some embodiments, the first lateral edge 92 and/or the second lateral edge 94 may be oblique relative to the groove edge 86. In some embodiments, the first lateral edge 92 and/or the second lateral edge 94 may form an acute angle AA with the groove edge 86. As shown in FIGS. 8A and 8B, in some embodiments, the groove edge 86 may include a first groove edge segment 140 extending between the first lateral edge 92 and the groove recess 138, and/or a second groove edge segment 142 extending between the second lateral edge 94 and the groove recess 138. The first groove edge segment 140 may be substantially straight, and/or the second groove edge segment 142 may be substantially straight. In some embodiments consistent with FIGS. 8A and 8B, the seal cross-section 84 may have bilateral symmetry relative to the radial axis R of the seal 14.

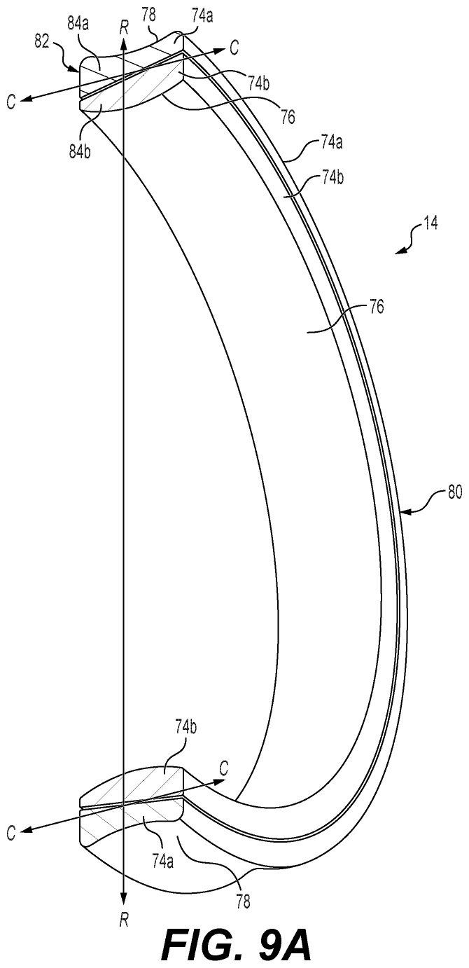

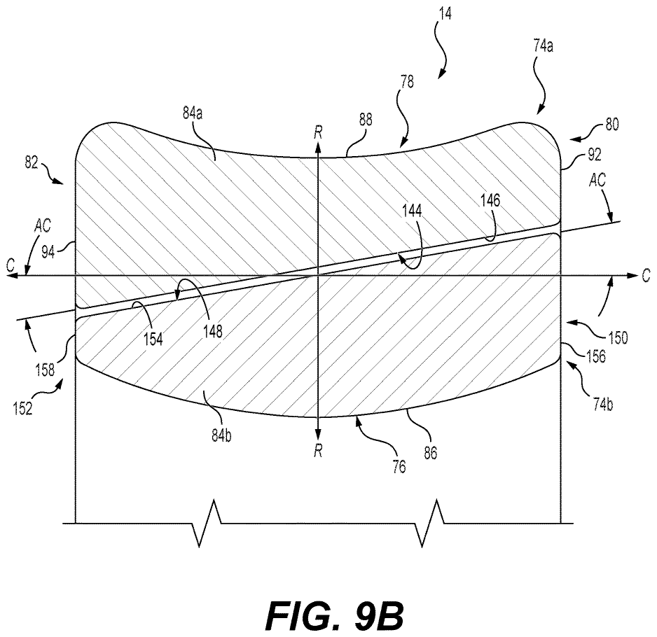

FIG. 9A is a schematic perspective section view of another example seal 14 to enhance a fluid seal between an outer surface of a first component having a substantially circular cross-section and an inner surface of a second component, according to embodiments of the disclosure, and FIG. 9B is a schematic section view of the example seal 14 shown in FIG. 9A in an uncompressed condition. As shown in FIGS. 9A and 9B, in some embodiments, the seal 14 may include a first annular seal body 74a and a second annular seal body 74b. The first annular seal body 74a may have a first intermediate face 144 positioned to face toward a groove of the first component or the second component, and a sealing face 78 opposite the first intermediate face 144 and positioned to face away from the first intermediate face 144. The first annular seal body 74a further may have a first lateral face 80 extending between the first intermediate face 144 and the sealing face 78, and a second lateral face 82 opposite the first lateral face 80 and extending between the first intermediate face 144 and the sealing face 78. The first annular seal body 74a may have a first seal cross-section 84a at least partially defined by the first intermediate face 144, the sealing face 78, the first lateral face 80, and the second lateral face 82. The first seal cross-section 84a may have a first intermediate edge 146 at least partially defined by the first intermediate face 144, and the first intermediate edge 146 may, in at least some embodiments, be oblique with respect to the circumferential axis C of the seal 14. The first seal cross-section 84a further may have a sealing edge 88 at least partially defined by the sealing face 78, and the sealing edge 88 may be at least partially concave, for example, as shown in FIGS. 9A and 9B. The first lateral edge 92 may be at least partially defined by the first lateral face 80. The first seal cross-section 84a also may have a second lateral edge 94 at least partially defined by the second lateral face 82, and the second lateral edge 94 may be at least partially concave, for example, as shown in FIGS. 9A and 9B.

As shown in FIGS. 9A and 9B, the second annular seal body 74b may have a groove face 76 positioned to face the groove of the first component or the second component, and a second intermediate face 148 opposite the groove face 76 and positioned to face away from the groove face 76. The second intermediate face 148 may be adjacent the first intermediate face 144. The second annular seal body 74b further may have a third lateral face 150 extending between the groove face 76 and the second intermediate face 148, and the third lateral face 150 may provide an extension of the first lateral face 80 of the first annular seal body 74a. The second annular seal body 74b also may have a fourth lateral face 152 opposite the third lateral face 150 and extending between the groove face 76 and the second intermediate face 148, and the fourth lateral face 152 may provide an extension of the second lateral face 82 of the first annular seal body 74a. The second annular seal body 74b may have a second seal cross-section 84b at least partially defined by the groove face 76, the second intermediate face 148, the third lateral face 150, and the fourth lateral face 152. As shown in FIGS. 9A and 9B, the second seal cross-section 84b may have a groove edge 86 at least partially defined by the groove face 76, and a second intermediate edge 154 at least partially defined by the second intermediate face 148. The second seal cross-section 84b further may have a third lateral edge 156 at least partially defined by the third lateral face 150, and a fourth lateral edge 158 at least partially defined by the fourth lateral face 152. The first annular seal body 74a and/or the second annular seal body 74b may be positioned to cause the seal 14 to compress and deform in the groove of the first component or the second component when the other of the first component or the second component presses against the sealing face 78 of the first annular seal body 74a in a direction toward the groove face 76, thereby to expand the first annular seal body 74a and the second annular seal body 74b outward from: (a) the first lateral face 80 and the third lateral face 150, and (b) the second lateral face 82 and the fourth lateral face 152, thereby to enhance the fluid seal between the first component and the second component.

In some embodiments, as shown in FIGS. 9A and 9B, the first intermediate edge 146 and/or the second intermediate edge 154 may form an acute angle AC with the circumferential axis C of the seal 14. For example, the first intermediate edge 146 and/or the second intermediate edge 154 may form an angle AC with the circumferential axis C of the seal 14 ranging from about 15 degrees to about 75 degrees.

In at least some embodiments consistent with FIGS. 9A and 9B, the first annular seal body 74a may include (or be formed from) a first material, and the second annular seal body 74b may include (or be formed from) a second material, with the first material being different than the second material. In some embodiments, the first material may have a different hardness than the second material. In some embodiments, the first material and the second material may be substantially the same material. The first annular seal body 74a may be connected to the second annular seal body 74b at the first intermediate face 144 and the second intermediate face 148. For example, the first annular seal body 74a and the second annular seal body 74b may be co-extruded, and/or the first annular seal body 74a and the second annular seal body 74b may be adhesively secured to one another.

As shown in FIGS. 9A and 9B, in some embodiments, the groove edge 86 may be substantially convex. In some embodiments, the seal cross-section 84, for example, the combined first seal cross-section 84a and second seal cross-section 84b, may have bilateral symmetry relative to the radial axis R of the seal 14.

In some embodiments consistent with FIGS. 9A and 9B, upon compression into the groove, the first annular seal body 74a and the second annular seal body 74b may interact, for example, along the first intermediate face 144 and the second intermediate face 146, thereby causing (a) the first annular seal body 74a to deform laterally outward at the second lateral face 94 toward the second groove side wall 134 (see, e.g., example annular groove 70 shown in FIGS. 6A-6C), and (b) the first annular seal body 74b to deform laterally outward at the third lateral face 150 toward the first groove side wall 132. This example activation may result in enhancing the fluid seal between the first component and the second component.

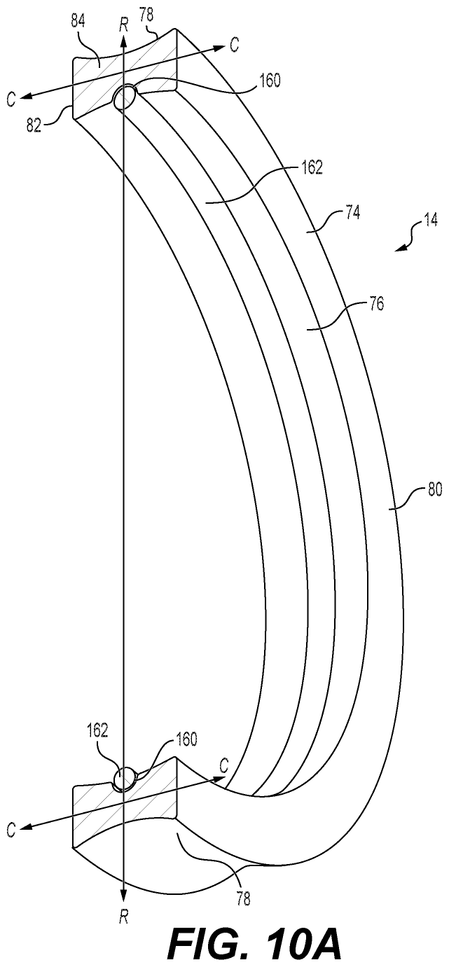

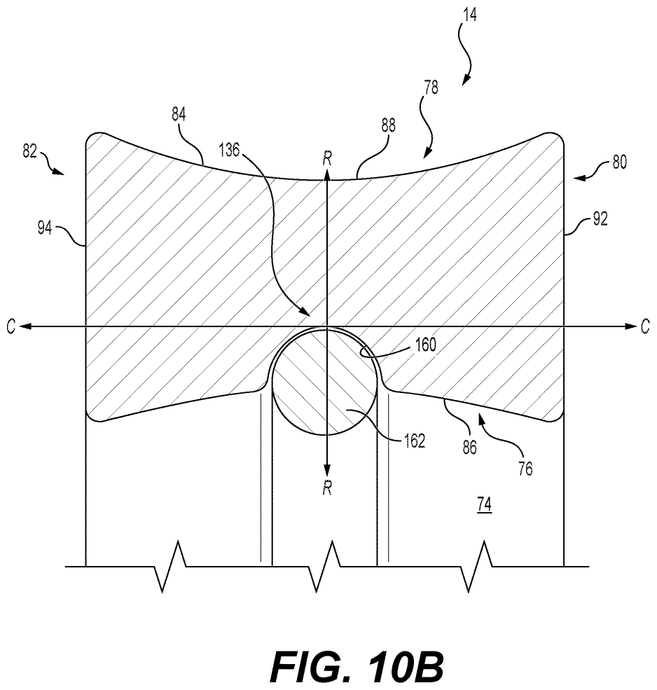

FIG. 10A is a schematic perspective section view of another example seal 14 to enhance a fluid seal between an outer surface of a first component having a substantially circular cross-section and an inner surface of a second component, according to embodiments of the disclosure, and FIG. 10B is a schematic section view of the example seal 14 shown in FIG. 10A in an uncompressed condition. As shown in FIGS. 10A and 10B, the seal 14 may include an annular seal body 74, and the annular seal body 74 may have a seal cross-section 84 at least partially defined by a groove face 76, a sealing face 78, a first lateral face 80, and a second lateral face 82. The seal cross-section 84, in some embodiments, may have a groove edge 86 at least partially defined by the groove face 76, and a sealing edge 88 at least partially defined by the sealing face 78. The seal cross-section 84 further may have a first lateral edge 92 at least partially defined by the first lateral face 80, and a second lateral edge 94 at least partially defined by the second lateral face 82. As shown in FIGS. 10A and 10B, in some embodiments, the groove edge 86 may at least partially define a groove edge recess 160 between the first lateral edge 92 and the second lateral edge 94. In some embodiments, the seal 14 further may include an O-ring 162 received in the groove edge recess 160 of the groove face 76, for example, as shown. The groove face 76, the O-ring 162, the sealing face 78, the first lateral face 80, and/or the second lateral face 82 may be positioned to cause the seal 14 to compress and deform in the groove of the first component or the second component when the other of the first component or the second component presses against the sealing face 78 in a direction toward the groove face 76, thereby to expand the annular seal body 74 laterally outward from the first lateral face 80 and the second lateral face 82, thereby to enhance the fluid seal between the first component and the second component.

In some embodiments consistent with FIGS. 10A and 10B, the groove face 76, the O-ring 162, the sealing face 78, the first lateral face 80, and/or the second lateral face 82 may be positioned to cause the seal 14 to compress and deform in the groove of the first component or the second component when the other of the first component or the second component presses against the sealing face 78 in a direction toward the groove face 76, thereby to press the O-ring 162 against the groove of the first component or the second component, thereby to enhance the fluid seal between the first component and the second component.

As shown in FIGS. 10A and 10B, the groove edge 86 may be at least partially concave. In some embodiments, the sealing edge 88 may be at least partially concave. In some embodiments, a radially inward facing portion of the O-ring 162 may have a relatively smaller radius than the groove face 76 of the annular seal body 74. In some such embodiments, the radially inward facing portion of the O-ring 162 may contact the groove the first component or the second component before the groove face 76 of the annual seal body 74, for example, when the groove is in an outer diameter of a component having a substantially cylindrical outer surface. In some embodiments, a radially outward facing portion of the O-ring 162 may have a relatively larger radius than the groove face 76 of the annular seal body 74. In some such embodiments, the radially outward facing portion of the O-ring 162 may contact the groove the first component or the second component before the groove face 76 of the annual seal body 74, for example, when the groove is in an inner diameter of a component having a substantially cylindrical inner surface.

In some embodiments consistent with FIGS. 10A and 10B, the groove edge 86 and the sealing edge 88 may form an area 136 between the first lateral edge 92 and the second lateral edge 94 having a relatively reduced thickness. In at least some such embodiments, the groove face 76, the O-ring 162, the sealing face 78, the first lateral face 80, and/or the second lateral face 82 may be positioned to cause the seal 14 to deform in the groove of the first component or the second component when the other of the first component or the second component presses against the sealing face 78 in a direction toward the groove face 76, thereby to compress the area 136 between the first lateral edge 92 and the second lateral edge 94.

In some embodiments, the first lateral edge 92 and/or the second lateral edge 94 may be substantially planar, for example, as shown in FIGS. 10A and 10B. In some embodiments, the first lateral edge 92 and the second lateral edge 94 may be substantially parallel to one another. The first lateral edge 92 and/or the second lateral edge 94 may be substantially parallel to the radial axis R of the seal 14. In some embodiments, the seal cross-section 84 and the cross-section of the O-ring 162 may have a combined seal cross-section, and the combined seal cross-section may have bilateral symmetry relative to the radial axis R of the seal 14.

In at least some embodiments consistent with FIGS. 10A and 10B, the presence of the O-ring 162 may result in causing ends of the first lateral face 80 and the second lateral face 82 adjacent the groove face 76 to spread laterally outward toward the first groove side wall 132 and the second groove side wall 134 at the groove bottom 130 when the seal 14 is compressed and deformed by a component into the annular groove 70 (or 72) (see, e.g., example annular groove 70 shown in FIGS. 6A-6C). In addition, the presence of the O-ring 162 at the groove face 76 may result in pressing the O-ring 162 against the groove 130 when the seal 14 is compressed and deformed by the component. These example activations may result in enhancing the fluid seal between the first component and the second component.

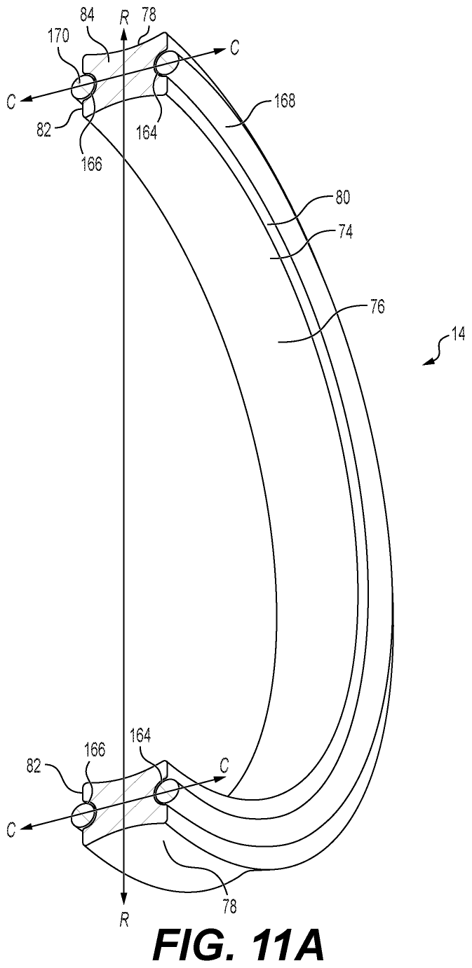

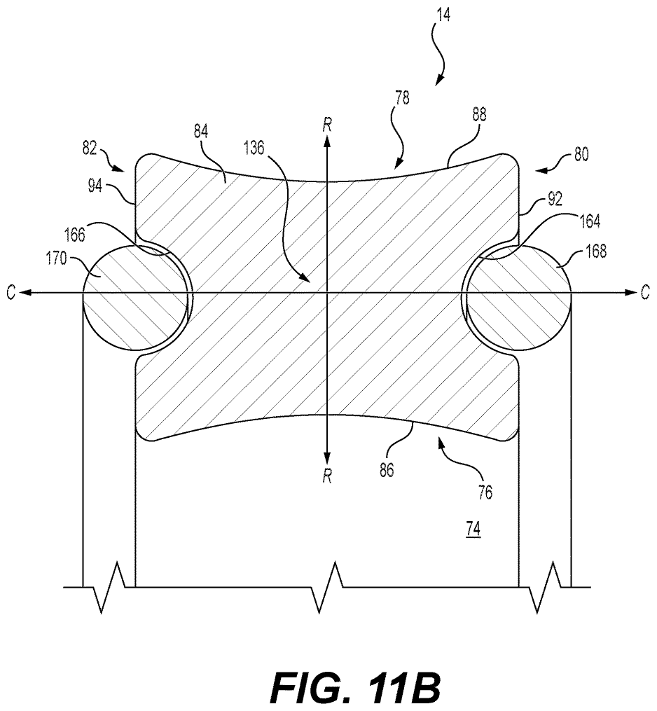

FIG. 11A is a schematic perspective section view of another example seal 14 to enhance a fluid seal between an outer surface of a first component having a substantially circular cross-section and an inner surface of a second component, according to embodiments of the disclosure, and FIG. 11B is a schematic section view of the example seal 14 shown in FIG. 11A in an uncompressed condition. As shown in FIGS. 11A and 11B, the seal 14 may include an annular seal body 74, and the annular seal body 74 may have a seal cross-section 84 at least partially defined by a groove face 76, a sealing face 78, a first lateral face 80, and a second lateral face 82. The seal cross-section 84, in some embodiments, may have a groove edge 86 at least partially defined by the groove face 76, and a sealing edge 88 at least partially defined by the sealing face 78. The seal cross-section 84 further may have a first lateral edge 92 at least partially defined by the first lateral face 80, and the first lateral edge 92 may at least partially define a first lateral recess 164 between the groove edge 86 and the sealing edge 88. The seal cross-section 84 also may have a second lateral edge 94 at least partially defined by the second lateral face 82, and the second lateral edge 94 may at least partially define a second lateral recess 166 between the groove edge 86 and the sealing edge 88.

In some embodiments, for example, as shown in FIGS. 11A and 11B, the seal 14 further may include a first O-ring 168 at least partially received in the first lateral recess 164 of the first lateral face 80 and a second O-ring 170 at least partially received in the second lateral recess 166 of the second lateral face 82. The groove face 76, the first O-ring 168, the second O-ring 170, the sealing face 78, the first lateral face 80, and/or the second lateral face 82 may be positioned to cause the seal 14 to compress and deform in the groove of the first component or the second component when the other of the first component or the second component presses against the sealing face 78 in a direction toward the groove face 76, thereby to expand the annular seal body 74 laterally outward from the first lateral face 80 and the second lateral face 82 and press the first O-ring 168 and the second O-ring 170 against walls of the groove, thereby to enhance the fluid seal between the first component and the second component.

In some embodiments consistent with FIGS. 11A and 11B, the groove edge 86 may be at least partially concave. In some embodiments, the sealing edge 88 may be at least partially concave, for example, as shown in FIGS. 11A and 11B. In some embodiments, the groove edge 86 and the sealing edge 88 may form an area 136 between the first lateral edge 92 and the second lateral edge 94 having a relatively reduced thickness, for example, as compared to the thickness of the seal 14 at the first lateral edge 92 and the second lateral edge 94. In some embodiments, the groove face 76, the first O-ring 168, the second O-ring 170, the sealing face 78, the first lateral face 80, and/or the second lateral face 82 may be positioned to cause the seal 14 to compress and deform in the groove of the first component or the second component when the other of the first component or the second component presses against the sealing face 78 in a direction toward the groove face 76, thereby to compress the area 136 between the first lateral edge 92 and the second lateral edge 94.

In at least some embodiments consistent with FIGS. 11A and 11B, the presence of the first and second O-rings 168 and 170 may result in causing ends of the first lateral face 80 and the second lateral face 82 adjacent the groove face 76 to be pressed into respective corners of the annular groove 70, for example, where the first groove side wall 132 and the second groove side wall 134 meet the groove bottom 130 when the seal 14 is compressed and deformed by a component into the annular groove 70 (or 72) (see, e.g., the example annular groove 70 shown in FIGS. 6A-6C). In addition, the presence of the first and second O-rings 168 and 170 at the first groove side wall 132 and the second groove side wall 134, respectively, may result in pressing the O-rings 168 and 170 against the respective first groove side wall 132 and second groove side wall 134 when the seal 14 is compressed and deformed by the component. These example activations may result in enhancing the fluid seal between the first component and the second component.

As shown in FIGS. 11A and 11B, in some embodiments, the first O-ring 168 may extend laterally outward beyond the first lateral edge 92 of the annular seal body 74, and/or the second O-ring 170 may extend laterally outward beyond the second lateral edge 94 of the annular seal body 74. In some embodiments, the first lateral edge 92 may be substantially planar on both sides of the first lateral recess 164, and/or the second lateral edge 94 may be substantially planar on both sides of the second lateral recess 166, for example, as shown. In some embodiments, the first lateral edge 92 and the second lateral edge 94 may be substantially parallel to one another. In some embodiments, the first lateral edge 92 and/or the second lateral edge 94 may be substantially parallel to the radial axis R of the seal 14, for example, as shown. In some embodiments, the seal cross-section 84, the cross-section of the first O-ring 168, and cross-section of the second O-ring 170 may have a combined seal cross-section, and the combined seal cross-section may have bilateral symmetry relative to the radial axis R of the seal 14. In some embodiments, for example, as shown in FIGS. 11A and 11B, the combined seal cross-section may have bilateral symmetry relative to the circumferential axis C of the seal 14.

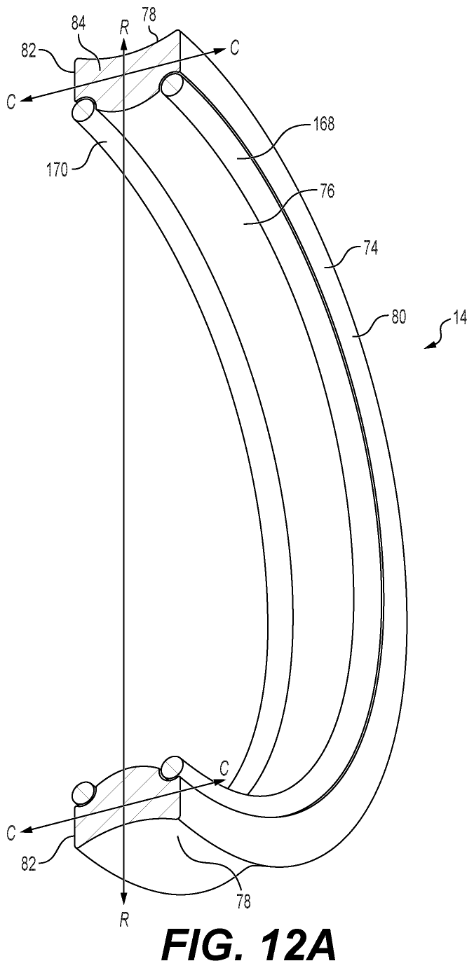

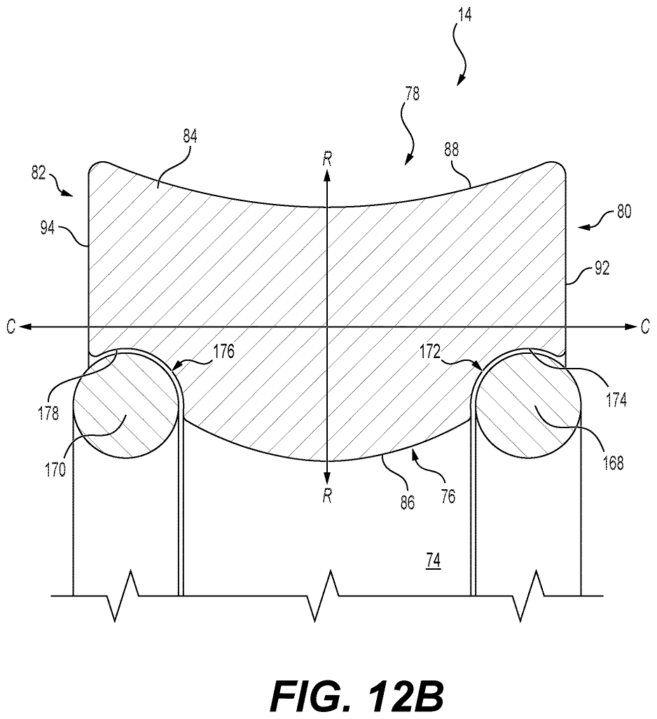

FIG. 12A is a schematic perspective section view of another example seal 14 to enhance a fluid seal between an outer surface of a first component having a substantially circular cross-section and an inner surface of a second component, according to embodiments of the disclosure, and FIG. 12B is a schematic section view of the example seal 14 shown in FIG. 12A in an uncompressed condition. As shown in FIGS. 12A and 12B, the seal 14 may include an annular seal body 74, and the annular seal body 74 may have a seal cross-section 84 at least partially defined by a groove face 76, a sealing face 78, a first lateral face 80, and a second lateral face 82. The seal cross-section 84, in some embodiments, may have a groove edge 86 at least partially defined by the groove face 76, and a sealing edge 88 at least partially defined by the sealing face 78. The seal cross-section 84 further may have a first lateral edge 92 at least partially defined by the first lateral face 80, and the first lateral edge 92 and the groove edge 86 may meet at a first groove edge intersection 172. The first lateral edge 92 and/or the groove edge 86 may at least partially define a first intersection recess 174 at the first groove edge intersection 172. The seal cross-section 84 also may have a second lateral edge 94 at least partially defined by the second lateral face 82, and the second lateral edge 94 and the groove edge 86 may meet at a second groove edge intersection 176. The second lateral edge 94 and/or the groove edge 86 may at least partially define a second intersection recess 178 at the second groove edge intersection 176. The seal 14 further may include a first O-ring 168 at least partially received in the first intersection recess 174, and a second O-ring 170 at least partially received in the second intersection recess 178. In some embodiments, the groove face 76, the first O-ring 168, the second O-ring 170, the sealing face 78, the first lateral face 80, and/or the second lateral face 82 may be positioned to cause the seal 14 to compress and deform in the groove of the first component or the second component when the other of the first component or the second component presses against the sealing face 78 in a direction toward the groove face 76, thereby to expand the annular seal body 74 laterally outward from the first lateral face 80 and the second lateral face 82 and press the first O-ring 168 and the second O-ring 170 against walls of the groove, thereby to enhance the fluid seal between the first component and the second component.

In some embodiments, the groove edge 86 may be at least partially convex, for example, as shown in FIGS. 12A and 12B. In some embodiments, the sealing edge 88 may be at least partially concave. In some embodiments, the groove face 76, the first O-ring 168, the second O-ring 170, the sealing face 78, the first lateral face 80, and/or the second lateral face 82 may be positioned to cause the seal 14 to compress and deform in the groove of the first component or the second component when the other of the first component or the second component presses against the sealing face 78 in a direction toward the groove face 76, thereby to push an area 136 of the seal 14 between the first lateral edge 92 and the second lateral edge 94 against the first component or the second component.

In at least some embodiments consistent with FIGS. 12A and 12B, the presence of the first and second O-rings 168 and 170 at the respective first groove edge intersection 172 and second groove edge intersection 176 may result in causing the first and second O-rings 168 and 170 to be pressed into respective corners of the annular groove 70, where the first groove side wall 132 and the second groove side wall 134 meet the groove bottom 130 when the seal 14 is compressed and deformed by a component into the annular groove 70 (or 72) (see, e.g., the example annular groove 70 shown in FIGS. 6A-6C). In addition, the presence of the first and second O-rings 168 and 170 at the first groove side wall 132 and the second groove side wall 134, respectively, may result in pressing the O-rings 168 and 170 against the respective first groove side wall 132 and second groove side wall 134 when the seal 14 is compressed and deformed by the component. These example activations may result in enhancing the fluid seal between the first component and the second component.

In some embodiments, the first O-ring 168 and/or the second O-ring 170 may extend laterally outward beyond the first lateral edge 92 and/or the second the second lateral edge 94, respectively, for example, in the uncompressed state, as shown in FIGS. 12A and 12B. In some embodiments, the first lateral edge 92 may be substantially planar between the first intersection recess 174 and the sealing edge 88, and/or the second lateral edge 94 may be substantially planar between the second intersection recess 178 and the sealing edge 88.

In some embodiments, a radially inward facing portion of the first O-ring 168 and/or a radially inward facing portion of the second O-ring 170 may have a relatively smaller radius than the groove face 76 of the annular seal body 74. In some such embodiments, the radially inward facing portion of the first O-ring 168 and/or the second O-ring 170 may contact the groove the first component or the second component before the groove face 76 of the annual seal body 74, for example, when the groove is in an outer diameter of a component having a substantially cylindrical outer surface. In some embodiments, a radially outward facing portion of the first O-ring 168 and/or a radially outward facing portion of the second O-ring 170 may have a relatively larger radius than the groove face 76 of the annular seal body 74. In some such embodiments, the radially outward facing portion of the first O-ring 168 and/or the second O-ring 170 may contact the groove the first component or the second component before the groove face 76 of the annual seal body 74, for example, when the groove is in an inner diameter of a component having a substantially cylindrical inner surface.

For at least some embodiments consistent with FIGS. 12A and 12B, the first lateral edge 92 and the second lateral edge 94 may be substantially parallel to one another. In some embodiments, the first lateral edge 92 may be substantially parallel to the radial axis R of the seal 14, and/or the second lateral edge 94 may be substantially parallel to the radial axis R of the seal 14. In some embodiments, the seal cross-section 84, the cross-section of the first O-ring 168, and cross-section of the second O-ring 170 may have a combined seal cross-section, and the combined seal cross-section may have bilateral symmetry relative to the radial axis R of the seal 14.

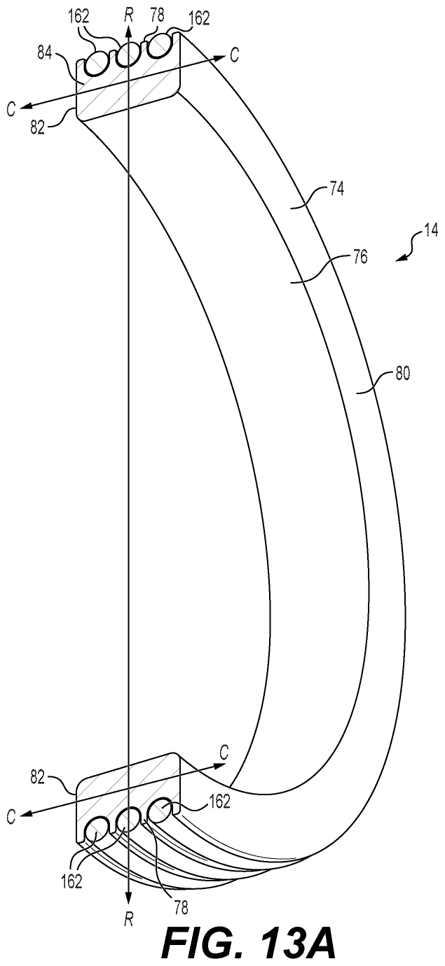

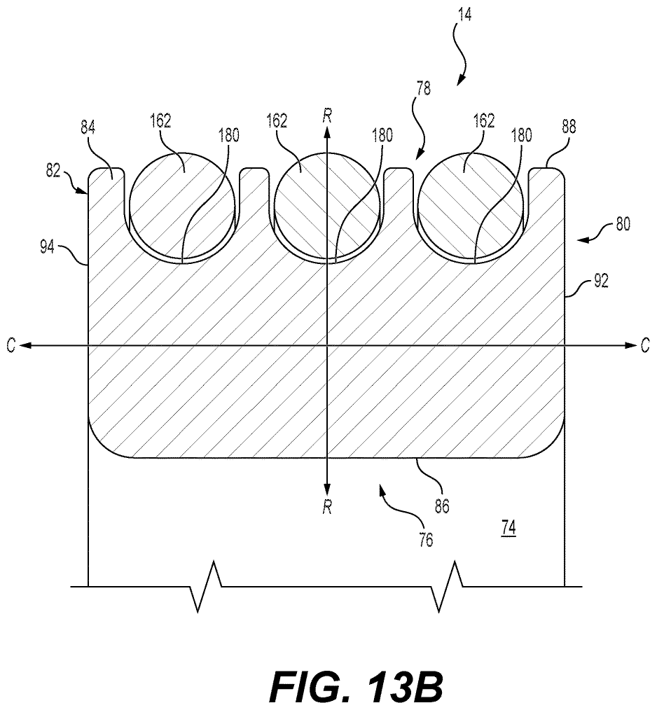

FIG. 13A is a schematic perspective section view of another example seal 14 to enhance a fluid seal between an outer surface of a first component having a substantially circular cross-section and an inner surface of a second component, according to embodiments of the disclosure, and FIG. 13B is a schematic section view of the example seal 14 shown in FIG. 13A in an uncompressed condition. As shown in FIGS. 13A and 13B, the seal 14 may include an annular seal body 74, and the annular seal body 74 may have a seal cross-section 84 at least partially defined by a groove face 76, a sealing face 78, a first lateral face 80, and a second lateral face 82. The seal cross-section 84, in some embodiments, may have a groove edge 86 at least partially defined by the groove face 76, and a sealing edge 88 at least partially defined by the sealing face 78. The seal cross-section 84 further may have a first lateral edge 92 at least partially defined by the first lateral face 80, and a second lateral edge 94 at least partially defined by the second lateral face 82. As shown in FIGS. 13A and 13B, in some embodiments, the sealing edge 88 may at least partially define a plurality of sealing edge recesses 180 between the first lateral edge 92 and the second lateral edge 94. The seal 14 further may include a plurality of O-rings 162. Each of the plurality of O-rings 162 may be received in one of the plurality of sealing edge recesses 180 of the sealing face 78. In some embodiments consistent with FIGS. 13A and 13B, the groove face 76, the plurality of O-rings 162, the sealing face 78, the first lateral face 80, and/or the second lateral face 82 may be positioned to cause the seal 14 to compress and deform in the groove of the first component or the second component when the other of the first component or the second component presses against the plurality of O-rings 162 in a direction toward the groove face 76, thereby to expand the annular seal body 74 laterally outward from the first lateral face 80 and the second lateral face 82, thereby to enhance the fluid seal between the first component and the second component.

In some embodiments consistent with FIGS. 13A and 13B, the groove face 76, the plurality of O-rings 162, the sealing face 78, the first lateral face 80, and/or the second lateral face 82 may be positioned to cause the seal 14 to compress and deform in the groove of the first component or the second component when the other of the first component or the second component presses against the plurality of O-rings 162 in the direction toward the groove face 76, thereby to press the plurality of O-rings 162 against the other of the first component or the second component, thereby to enhance the fluid seal between the first component and the second component.

For example, in at least some embodiments consistent with FIGS. 13A and 13B, the presence of the O-rings 162 at the sealing face 78 may result in causing ends of the first lateral face 80 and the second lateral face 82 adjacent the sealing face 78 to deform laterally outward against respective portions of the first groove side wall 132 and the second groove side wall 134 adjacent the open portion 135 of the annular groove 70 when the seal 14 is compressed and deformed by a component into the annular groove (see, e.g., example annular groove 70 shown in FIGS. 6A-6C). In addition, the presence of the O-rings 162 at the sealing face 78 may result in pressing the O-rings 162 against the component when the seal 14 is compressed and deformed by the component. These example activations may result in enhancing the fluid seal between the first component and the second component.

In some embodiments, respective radially outward facing portions of the plurality O-rings 162 may have a larger radius than the sealing face 78 of the annular seal body 74. In some such embodiments, the respective radially outward facing portions of the O-rings 162 may contact the other of the first component or the second component before the sealing face 78 of the annual seal body 74, for example, when the groove is in an outer diameter of a component having a substantially cylindrical outer surface. In some embodiments, respective radially inward facing portions of the plurality of O-rings 162 may have a smaller radius than the sealing face 78 of the annular seal body 74. In some such embodiments, the respective radially inward facing portions of the O-rings 162 may contact the other of the first component or the second component before the sealing face 78 of the annual seal body 74, for example, when the groove is in an inner diameter of a component having a substantially cylindrical inner surface.

As shown in FIGS. 13A and 13B, in some embodiments, the first lateral edge 92 and/or the second lateral edge 94 may be substantially planar. In some embodiments, the first lateral edge 92 and second lateral edge 94 may be substantially parallel to one another. As shown in FIGS. 13A and 13B, the first lateral edge 92 and/or the second lateral edge 94 may be substantially parallel to the radial axis R of the seal 14. As shown in FIGS. 13A and 13B, the seal cross-section 84 and the respective cross-sections of the O-rings 162 may have a combined seal cross-section, and the combined seal cross-section may have bilateral symmetry relative to the radial axis R of the seal 14.

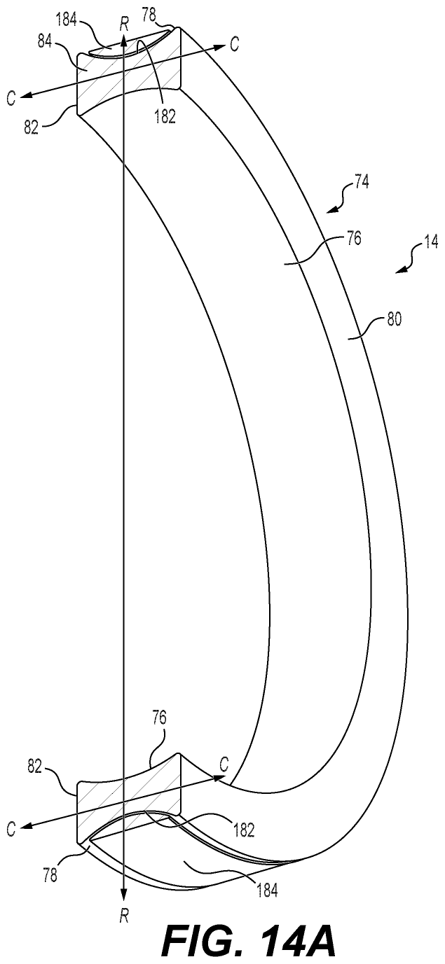

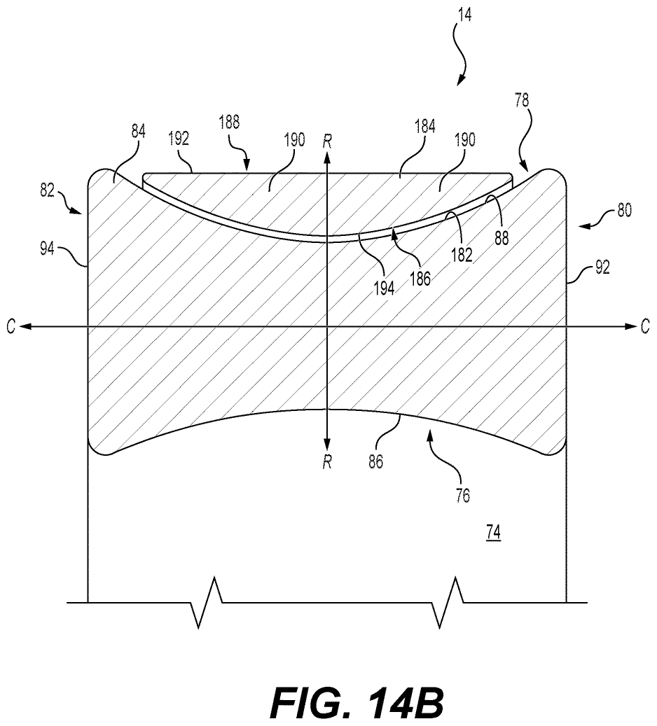

FIG. 14A is a schematic perspective section view of another example seal 14 to enhance a fluid seal between an outer surface of a first component having a substantially circular cross-section and an inner surface of a second component, according to embodiments of the disclosure, and FIG. 14B is a schematic section view of the example seal 14 shown in FIG. 14A in an uncompressed condition. As shown in FIGS. 14A and 14B, the seal 14 may include an annular seal body 74, and the annular seal body 74 may have a seal cross-section 84 at least partially defined by a groove face 76, a sealing face 78, a first lateral face 80, and a second lateral face 82. The seal cross-section 84, in some embodiments, may have a groove edge 86 at least partially defined by the groove face 76, and a sealing edge 88 at least partially defined by the sealing face 78. As shown in FIGS. 14A and 14B, in some embodiments, the sealing edge 88 may at least partially define a sealing edge recess 182. The seal cross-section 84 further may have a first lateral edge 92 at least partially defined by the first lateral face 80, and a second lateral edge 94 at least partially defined by the second lateral face 82. The seal further may include an annular stiffener 184 at least partially received in the sealing edge recess 182 of the annular seal body 74. The annular stiffener 184 may have a first stiffener face 186 adjacent the sealing face 78 of the annular seal body 74, and a second stiffener face 188 opposite the first stiffener face 186. The annular stiffener 184 further may have a stiffener cross-section 190 at least partially defined by the first stiffener face 186 and the second stiffener face 188. The stiffener cross-section 190 may have a first stiffener edge 192 at least partially defined by the first stiffener face 186, and the first stiffener edge 192 may be at least partially convex, for example, as shown in FIGS. 14A and 14B. The stiffener cross-section 190 further may have a second stiffener edge 194 at least partially defined by the second stiffener face 188.

In at least some embodiments consistent with FIGS. 14A and 14B, the groove face 76, the sealing face 78, the first lateral face 80, the second lateral face 82, the first stiffener face 186, and/or the second stiffener face 188 may be positioned to cause the seal 14 to compress and deform in the groove of the first component or the second component when the other of the first component or the second component presses against outer edges of the sealing face 78 and the second stiffener face 188 in a direction toward the groove face 76, thereby to expand the annular seal body 74 laterally outward from the first lateral face 80 and the second lateral face 82, thereby to enhance the fluid seal between the first component and the second component.

For example, in at least some embodiments consistent with FIGS. 14A and 14B, the presence of the annular stiffener 184 at the sealing face 78 may result in causing ends of the first lateral face 80 and the second lateral face 82 adjacent the sealing face 78 to deform laterally outward against respective portions of the first groove side wall 132 and the second groove side wall 134 adjacent the open portion 135 of the annular groove when the seal 14 is compressed and deformed by a component into the annular groove (see, e.g., the example annular groove 70 shown in FIGS. 6A-6C). These example activations may result in enhancing the fluid seal between the first component and the second component. In addition, the annular stiffener 184 may provide axial stiffness, for example, in the direction of the radial axis R, which may reduce the likelihood or prevent the seal 14 from expanding radially away from the annular groove, thereby securing the seal in the annular groove. In some embodiments, the annular stiffener 184 may reduce or prevent fretting damage resulting from seal compression.

In some embodiments, the annular seal body 74 may include (or be formed from) a first material, and the annular stiffener 184 may include (or be formed from) a second material, with the first material being different than the second material. In some such embodiments, the first material may have a different hardness than the hardness of the second material. For example, the hardness of the second material may be greater than the hardness of the first material. In some embodiments, the first material and the second material may be substantially the same material.

As shown in FIGS. 14A and 14B, in some embodiments, the groove edge 86 may be at least partially concave, and/or the sealing edge 88 may be at least partially concave and may at least partially form the sealing edge recess 182. The first stiffener edge 192 may be at least partially received by the sealing edge 88. In some embodiments, as shown in FIGS. 14A and 14B, the groove edge 86 and the sealing edge 88 may form an area between the first lateral edge 92 and the second lateral edge 94 having a relatively reduced thickness, for example, as compared to the thickness at the first lateral edge 92 and/or the second lateral edge 94.

In some embodiments consistent with FIGS. 14A and 14B, the groove face 76, the sealing face 78, the first lateral face 80, the second lateral face 82, the first stiffener face 186, and/or the second stiffener face 188 may be positioned to cause the seal 14 to compress and deform in the groove of the first component or the second component when the other of the first component or the second component presses against outer edges of the sealing face 78 and the second stiffener face 188 in the direction toward the groove face 76, thereby to compress the area between the first lateral edge 92 and the second lateral edge 94, thereby to enhance the fluid seal between the first component and the second component.

As shown in FIGS. 14A and 14B, the second stiffener edge 194 may be substantially straight. In some embodiments, the first lateral edge 92 and the second lateral edge 94 may be substantially parallel to one another. In at least some embodiments consistent with FIGS. 14A and 14B, the first lateral edge 92 and/or the second lateral edge 94 may be substantially parallel to the radial axis R of the seal 14. In some embodiments, the seal cross-section 84 and the stiffener cross-section 190 may have a combined seal cross-section, and the combined seal cross-section may have bilateral symmetry with respect to the radial axis R of the seal 14.

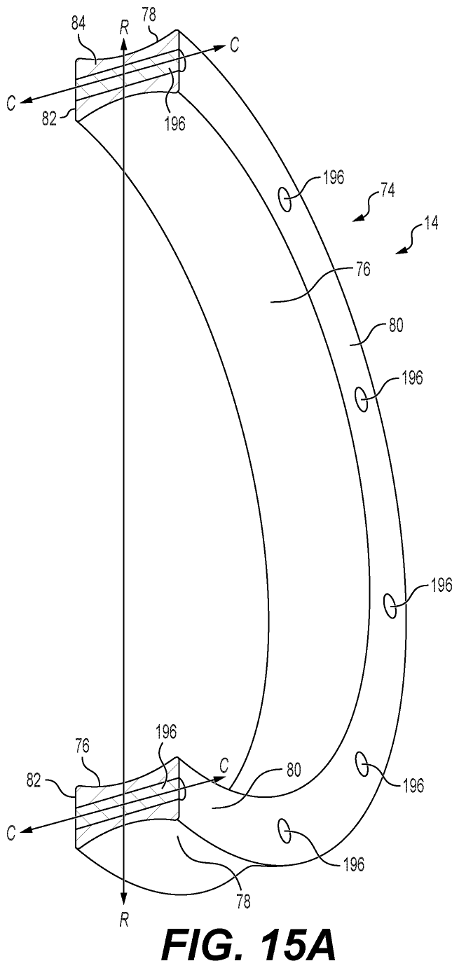

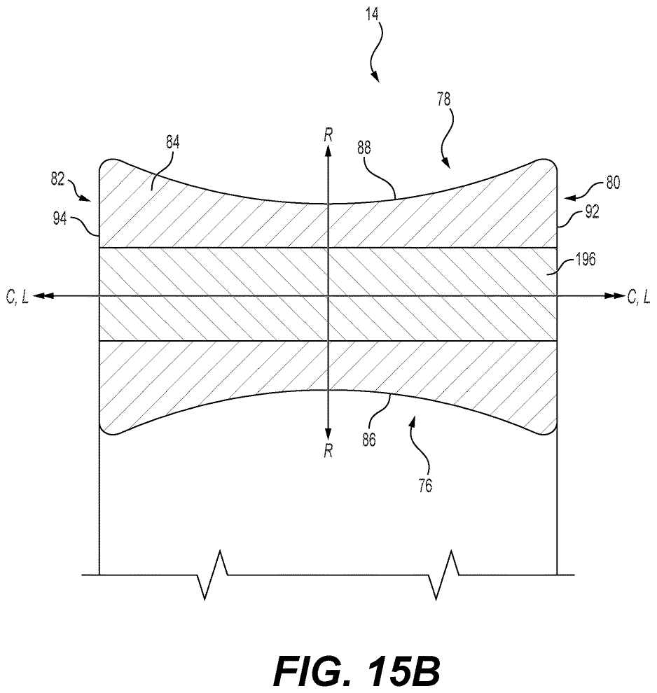

FIG. 15A is a schematic perspective section view of another example seal 14 to enhance a fluid seal between an outer surface of a first component having a substantially circular cross-section and an inner surface of a second component, according to embodiments of the disclosure, and FIG. 15B is a schematic section view of the example seal 14 shown in FIG. 15A in an uncompressed condition. As shown in FIGS. 15A and 15B, the seal 14 may include an annular seal body 74, and the annular seal body 74 may have a seal cross-section 84 at least partially defined by a groove face 76, a sealing face 78, a first lateral face 80, and a second lateral face 82. The seal cross-section 84, in some embodiments, may have a groove edge 86 at least partially defined by the groove face 76, and a sealing edge 88 at least partially defined by the sealing face 78. The seal cross-section 84 further may have a first lateral edge 92 at least partially defined by the first lateral face 80, and a second lateral edge 94 at least partially defined by the second lateral face 82. The seal 14 further may include a plurality of stiffeners 196 extending between the first lateral face 80 and the second lateral face 82 of the annular seal body 74. In some embodiments, the plurality of stiffeners 196 may be circumferentially spaced around the annular seal body 74, for example, as shown in FIG. 15A. The groove face 76, the sealing face 78, the first lateral face 801, the second lateral face 82, and/or one or more of the plurality of stiffeners 196 may be positioned to cause the seal 14 to compress and deform in the groove of the first component or the second component when the other of the first component or the second component presses against the sealing face 78 in a direction toward the groove face 76, thereby to expand the annular seal body 74 laterally outward from the first lateral face 80 and the second lateral face 82, thereby to enhance the fluid seal between the first component and the second component.

For example, in at least some embodiments consistent with FIGS. 15A and 15B, the presence of the plurality of stiffeners 196 may result in causing ends of the first lateral face 80 and the second lateral face 82 adjacent the groove face 76 and/or the ends of the first lateral face 80 and the second lateral face 82 adjacent the sealing face 78 to deform laterally outward against respective portions of the first groove side wall 132 and the second groove side wall 134, for example, adjacent the groove bottom 130 and/or adjacent open portion 135, respectively, of the annular groove when the seal 14 is compressed and deformed by a component into the annular groove (see, e.g., example annular groove 70 shown in FIGS. 6A-6C). These example activations may result in enhancing the fluid seal between the first component and the second component. In addition, the plurality of stiffeners 196 may provide stiffness, for example, in a direction parallel to the circumferential axis C, which may assist with securing the seal 14 the annular groove. In some embodiments, the plurality of stiffeners 196 may reduce or prevent fretting damage resulting from seal compression.

In at least some embodiments consistent with FIGS. 15A and 15B, one or more of the plurality of stiffeners 196 may be substantially cylindrical. In some embodiments, one or more of the plurality of stiffeners 196 may have a longitudinal axis L, and the longitudinal axis L of each of the one or more stiffeners 196 may extend in a direction substantially perpendicular to the radial axis R of the annular seal body 74 and/or substantially parallel to the circumferential axis C.

In some embodiments, the annular seal body 74 may include (or be formed from) a first material, and the one or more annular stiffeners may include (or be formed from) a second material, with the first material being different than the second material. In some embodiments, the first material may have a different hardness than the hardness of the second material. For example, the hardness of the second material may be relatively greater than the hardness of the first material. In some embodiments, the first material and the second material may be substantially the same material.

As shown in FIGS. 15A and 15B, the groove edge 86 may be at least partially concave, and/or the sealing edge 88 may be at least partially concave. In some embodiments consistent with FIGS. 15A and 15B, the groove edge 86 and/or the sealing edge 88 may form an area between the first lateral edge 92 and the second lateral edge 94 having a relatively reduced thickness, for example, as compared to the thickness at the first lateral edge 92 and/or the second lateral edge 94. In some embodiments consistent with FIGS. 15A and 15B, the groove face 76, the sealing face 78, the first lateral face 80, the second lateral face 82, and/or one or more of the plurality of stiffeners 196 may be positioned to cause the seal 14 to compress and deform in the groove of the first component or the second component when the other of the first component or the second component presses against outer edges of the sealing face 78 in the direction toward the groove face 76, thereby to compress the area between the first lateral edge 92 and the second lateral edge 94.

In some embodiments, as shown in FIGS. 15A and 15B, the first lateral edge 92 and the second lateral edge 94 may be substantially parallel to one another. In some embodiments, the first lateral edge 92 and/or the second lateral edge 94 may be substantially parallel to a radial axis R of the seal 14. As shown in FIGS. 15A and 15B, the seal cross-section 84 may have bilateral symmetry relative to the radial axis R of the seal 14, and/or the seal cross-section 84 may have bilateral symmetry relative to the circumferential axis C of the seal 14.

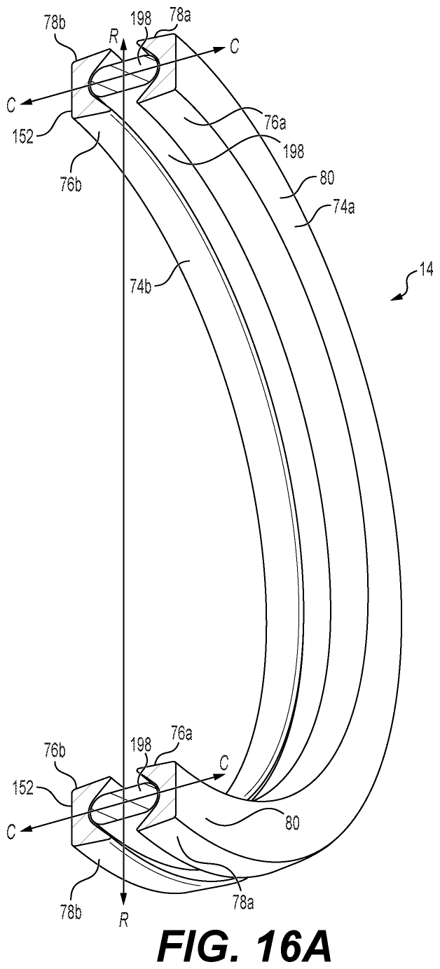

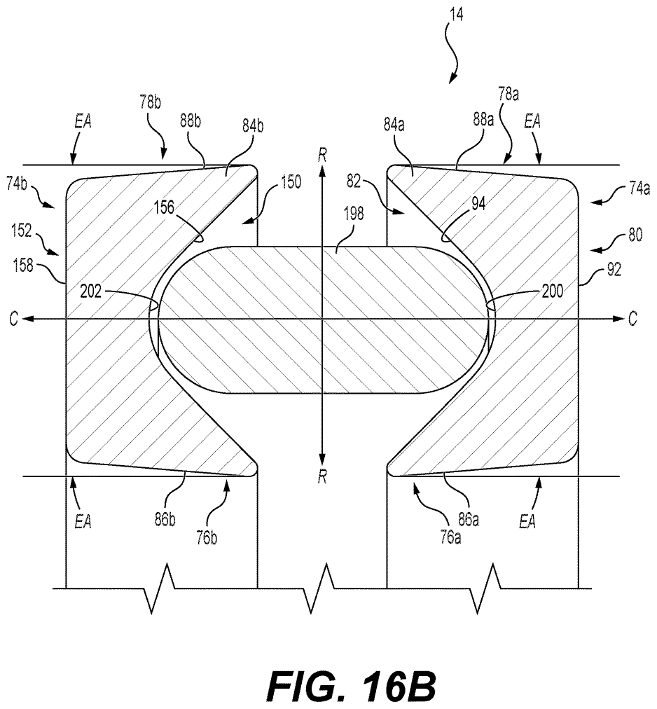

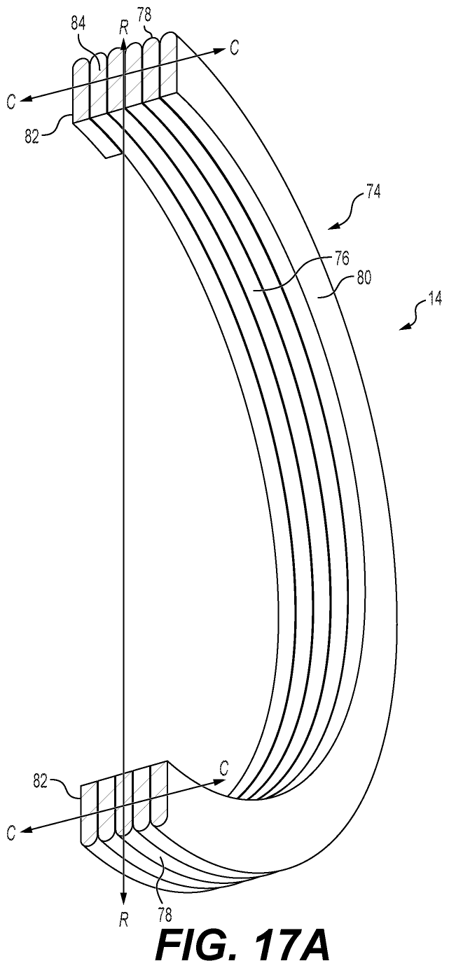

FIG. 16A is a schematic perspective section view of another example seal 14 to enhance a fluid seal between an outer surface of a first component having a substantially circular cross-section and an inner surface of a second component, according to embodiments of the disclosure, and FIG. 16B is a schematic section view of the example seal 14 shown in FIG. 16A in an uncompressed condition. As shown in FIGS. 16A and 16B, the seal 14 may include a first annular seal body 74a, a second annular seal body 74b, and an annular stiffener 198 between the first annular seal body 74a and the second annular seal body 74b. The annular first seal body 74a may have a first seal cross-section 84a at least partially defined by a first groove face 76a, a first sealing face 78a, a first lateral face 80, and a second lateral face 82. The first seal cross-section 84a, in some embodiments, may have a first groove edge 86a at least partially defined by the first groove face 76a, and a first sealing edge 88a at least partially defined by the first sealing face 78a. The first seal cross-section 84a further may have a first lateral edge 92 at least partially defined by the first lateral face 80, and a second lateral edge 94 at least partially defined by the second lateral face 82.

As shown in FIGS. 16A and 16B, in some embodiments, the second annular seal body 74b may have a second groove face 76b positioned to face the groove of the first component or the second component, and a second sealing face 78b opposite the second groove face 76b and positioned to face away from the second groove face 76b. The second annular seal body 74b further may have a third lateral face 150 extending between the second groove face 76b and the second sealing face 78b, and a fourth lateral face 152 opposite the third lateral face 150 and extending between the second groove face 76b and the second sealing face 78b. The second annular seal body 74b may have a second seal cross-section 84b at least partially defined by the second groove face 76b, the second sealing face 78b, the third lateral face 150, and the fourth lateral face 152. The second seal cross-section 84 may have a second groove edge 86b at least partially defined by the second groove face 76b, and a second sealing edge 88b at least partially defined by the second sealing face 78b. The second seal cross-section 84b also may have a third lateral edge 156 at least partially defined by the third lateral face 150 and facing toward the second lateral edge 94, and a fourth lateral edge 158 at least partially defined by the fourth lateral face 152.

In some embodiments, as shown in FIGS. 16A and 16B, the annular stiffener 198 may extend between the second lateral face 82 and the third lateral face 150. The first annular seal body 74a, the second annular seal body 74b, and/or the annular stiffener 198 may be positioned to cause the seal 14 to deform in the groove of the first component or the second component when the other of the first component or the second component presses against the first sealing face 78a and the second sealing face 78b in a direction toward the first groove face 76a and the second groove face 76b, thereby to expand the first annular seal body 74a laterally outward from the first lateral face 80 and the second annular seal body 74b outward from the fourth lateral face 152, thereby to enhance the fluid seal between the first component and the second component.

As shown in FIGS. 16A and 16B, the second lateral edge 94 may be at least partially concave and may form a second lateral edge recess 200, and/or the third lateral edge 156 may be at least partially concave and may form a third lateral edge recess 202. In some embodiments, the annular stiffener 198 may be at least partially received in the second lateral edge recess 200 and/or the third lateral edge recess 202, for example, as shown. As shown in FIGS. 16A and 16B, in some embodiments, the annular stiffener 198 may have a substantially oval-shaped cross-section.

In at least some embodiments consistent with FIGS. 16A and 16B, the first groove edge 86a, the first sealing edge 88a, the second groove edge 86b, and/or the second sealing edge 88b may extend obliquely with respect to the circumferential axis C of the seal 14. The first groove edge 86a, the first sealing edge 88a, the second groove edge 86b, and/or the second sealing edge 88b may extend in a direction forming an acute angle EA with respect to the circumferential axis C of the seal 14.

In some embodiments, the first groove edge 86a and the first sealing edge 88a may diverge from one another as the first groove edge 86a and the first sealing edge 88a extend from the first lateral edge 92 toward the second annular sealing body 74b, for example, as shown. In some embodiments, the second groove edge 86b and the second sealing edge 88b may diverge from one another as the second groove edge 86b and the second sealing edge 88b extend from the fourth lateral edge 158 toward the first annular sealing body 74a.

In at least some embodiments consistent with FIGS. 16A and 16B, as a component compresses and deforms the seal 14 into the annular groove, the annular stiffener 198 may act as a spacer substantially maintaining separation between the first annular seal body 74a and the second annular seal body 74b. This, in turn, may result in causing the first annular seal body 74a and the second annular seal body 74b to deform and expand laterally outward from the first lateral face 80 of the first annular seal body 74a and the fourth lateral face 152 of the second annular seal body 74b as the component compresses and deforms the first annular seal body 74a and the second annular seal body 74b. This deformation may result in causing that first annular seal body 74a and the second annular seal body 74b to substantially fill the annular groove where the first groove side wall 132 meets the groove bottom 130 and where the second groove side wall 134 meets the groove bottom 130 (see, e.g., the example annular groove 70 shown in FIGS. 6A-6C). In addition, as the component compresses and deforms the first annular seal body 74a and the second annular seal body 74b, the first annular seal body 74a and the second annular seal body 74b may deform and expand laterally outward from the first lateral face 80 of the first annular seal body 74a and the fourth lateral face 152 of the second annular seal body 74b adjacent the open portion 135 of the annular groove. These example activations may result in enhancing the fluid seal between the first component and the second component.

In some embodiments consistent with FIGS. 16A and 16B, the first annular seal body 74a and/or the second annular seal body 74b may include (or be formed from) a first material, and the annular stiffener 198 may include (or be formed from) a second material, with the first material being different than the second material. In some embodiments, the first material may have a different hardness than the hardness of the second material. For example, the hardness of the second material may be greater than the hardness of the first material. In some embodiments, the first material and the second material may be substantially the same material.

As shown in FIGS. 16A and 16B, the first lateral edge 92 and the fourth lateral edge 158 may be substantially parallel to one another. In some embodiments, the first lateral edge 92 and/or the fourth lateral edge 158 may be substantially parallel to the radial axis R of the seal 14. As shown in FIGS. 16A and 16B, the first seal cross-section 84a, the second seal cross-section 84b, and the stiffener cross-section 190 may have a combined seal cross-section having bilateral symmetry relative to the radial axis R of the seal 14 and/or the circumferential axis C of the seal 14.

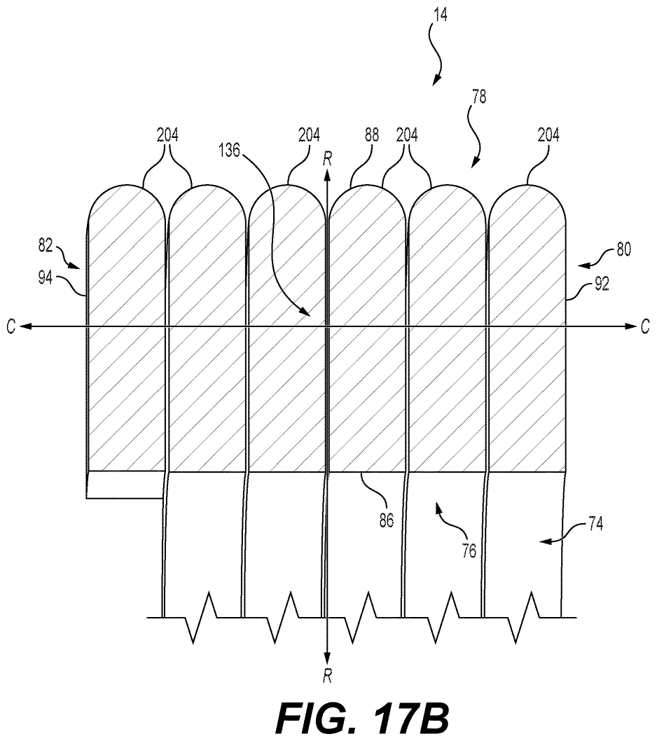

FIG. 17A is a schematic perspective section view of another example seal 14 to enhance a fluid seal between an outer surface of a first component having a substantially circular cross-section and an inner surface of a second component, according to embodiments of the disclosure, and FIG. 17B is a schematic section view of the example seal 14 shown in FIG. 17A in an uncompressed condition. As shown in FIGS. 17A and 17B, in some embodiments, the seal 14 may include an annular seal body 74 including a helically-wound material coil. The annular seal body 74 may have a seal cross-section 84 at least partially defined by a groove face 76, a sealing face 78, a first lateral face 80, and a second lateral face 82. As shown, in some embodiments, the seal cross-section 84 may have a groove edge 86 at least partially defined by the groove face 76. The seal cross-section further may have a sealing edge 88 at least partially defined by the sealing face 78. The seal cross-section 84 also may have a first lateral edge 92 at least partially defined by the first lateral face 80, and a second lateral edge 94 at least partially defined by the second lateral face 82. In some embodiments, the groove face 76, sealing face 78, the first lateral face 80, and/or the second lateral face 82 may be positioned to cause the seal 14 to compress and deform in the groove of the first component or the second component when the other of the first component or the second component presses against the sealing face 78 in a direction toward the groove face 76, thereby to expand the annular seal body 74 laterally outward from the first lateral face 80 and the second lateral face 82 and press against walls of the groove, thereby to enhance the fluid seal between the first component and the second component.

As shown in FIGS. 17A and 17B, the groove edge 86 may at least partially define a substantially flat surface positioned to face the groove of the first component or the second component. As shown, the sealing edge 88 may include a plurality of adjacent convex edge segments 204. In some embodiments consistent with FIGS. 17A and 17B, the groove face 76, the sealing face 78, the first lateral face 80, and/or the second lateral face 82 may be positioned to cause the seal 14 to compress and deform in the groove of the first component or the second component when the other of the first component or the second component presses against the sealing face 78 in a direction toward the groove face 76, thereby to push an area of the seal between the first lateral edge 92 and the second lateral edge 94 against the other of the first component or the second component, thereby to enhance the fluid seal between the first component and the second component.

For example, in at least some embodiments consistent with FIGS. 17A and 17B, as a component compresses and deforms the seal 14 into the annular groove, multiple sealing points against the surface of the component may be provided by the one or more coils of the material coil. In some embodiments, the material coil may be formed from (or include) a material having a relatively higher stiffness as compared to other embodiments of the seal 14 described herein. This may result in the seal 14 having a more precise fit in the annular groove, for example, such that the seal 14 more completely fills the annular groove and/or resists deformation that might lead to relatively faster degradation of the seal 14 and a reduced service life. This may provide a combination of (a) a relatively enhanced fluid seal between the first component and the second component and (b) a relatively longer service life.

As shown in FIGS. 17A and 17B, the first lateral edge 92 and second lateral edge 94 may be substantially parallel to one another. In some embodiments, the first lateral edge 92 and/or the second lateral edge 94 may be substantially parallel to the radial axis R of the seal 14. In some embodiments, the seal cross-section may have bilateral symmetry relative to the radial axis R of the seal 14, for example, as shown.

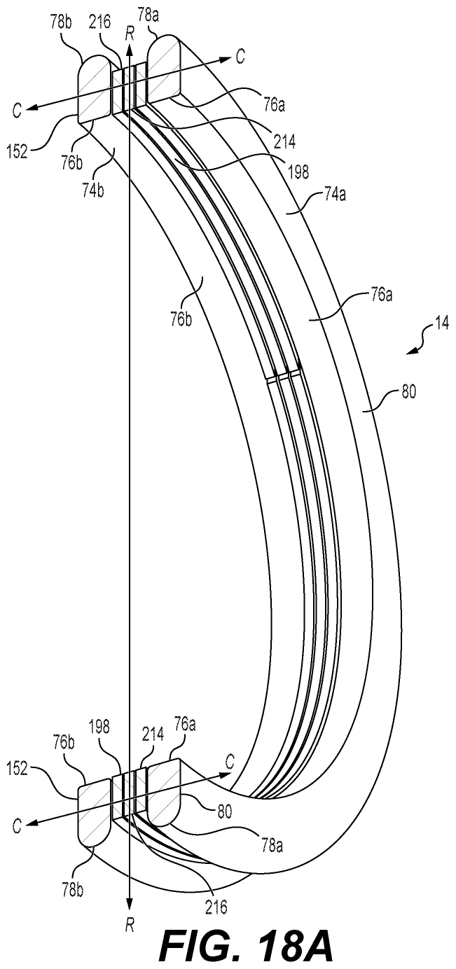

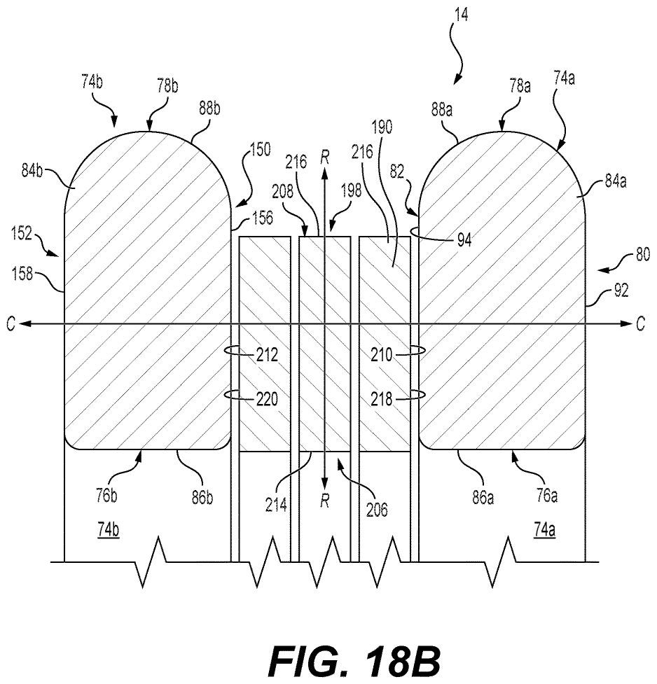

FIG. 18A is a schematic perspective section view of another example seal 14 to enhance a fluid seal between an outer surface of a first component having a substantially circular cross-section and an inner surface of a second component, according to embodiments of the disclosure, and FIG. 18B is a schematic section view of the example seal 14 shown in FIG. 18A in an uncompressed condition. As shown in FIGS. 18A and 18B, the seal 14 may include a first annular seal body 74a, a second annular seal body 74b, and an annular stiffener 198 between the first annular seal body 74a and the second annular seal body 74b. The annular first seal body 74a may have a first seal cross-section 84a at least partially defined by a first groove face 76a, a first sealing face 78a, a first lateral face 80, and a second lateral face 82. The first seal cross-section 84a, in some embodiments, may have a first groove edge 86a at least partially defined by the first groove face 76a, and a first sealing edge 88a at least partially defined by the first sealing face 78a. The first seal cross-section 84a further may have a first lateral edge 92 at least partially defined by the first lateral face 80, and a second lateral edge 94 at least partially defined by the second lateral face 82.

As shown in FIGS. 18A and 18B, in some embodiments, the second annular seal body 74b may have a second groove face 76b positioned to face the groove of the first component or the second component, and a second sealing face 78b opposite the second groove face 76b and positioned to face away from the second groove face 76b. The second annular seal body 74b further may have a third lateral face 150 extending between the second groove face 76b and the second sealing face 78b, and a fourth lateral face 152 opposite the third lateral face 150 and extending between the second groove face 76b and the second sealing face 78b. The second annular seal body 74b may have a second seal cross-section 84b at least partially defined by the second groove face 76b, the second sealing face 78b, the third lateral face 150, and the fourth lateral face 152. The second seal cross-section 84b may have a second groove edge 86b at least partially defined by the second groove face 76b, and a second sealing edge 88b at least partially defined by the second sealing face 78b. The second seal cross-section 84b also may have a third lateral edge 156 at least partially defined by the third lateral face 150 and facing toward the second lateral edge 94, and a fourth lateral edge 158 at least partially defined by the fourth lateral face 152.

In some embodiments, as shown in FIGS. 18A and 18B, the annular stiffener 198 may extend between the second lateral face 82 and the third lateral face 150. In some embodiments, as shown, the annular stiffener 198 may include a helically-wound material coil. The annular stiffener 198 may at least partially define a stiffener groove face 206 positioned to face the groove of the first component or the second component, and a stiffener sealing face 208 opposite the stiffener groove face 206 and positioned to face away from the stiffener groove face 206. The annular stiffener 198 further may at least partially define a first lateral stiffener face 210 extending between the stiffener groove face 206 and the stiffener sealing face 208. The first lateral stiffener face 210 may be adjacent the second lateral face 82 of the first annular seal body 74a. The annular stiffener 198 also may at least partially define a second lateral stiffener face 212 opposite the first lateral stiffener face 210 and extending between the stiffener groove face 206 and the stiffener sealing face 208. The second lateral stiffener face 212 maybe adjacent the third lateral face 150 of the second annular seal body 74b. The annular stiffener 198 may have a stiffener cross-section 190 at least partially defined by the stiffener groove face 206, the stiffener sealing face 208, the first lateral stiffener face 210, and the second lateral stiffener face 212. The stiffener cross-section 190 may have a stiffener groove edge 214 at least partially defined by the stiffener groove face 206, and a stiffener sealing edge 216 at least partially defined by the stiffener sealing face 208. The stiffener cross-section 190 further may have a first lateral stiffener edge 218 at least partially defined by the first lateral stiffener face 210, and a second lateral stiffener edge 220 at least partially defined by the second lateral stiffener face 212. In some embodiments, the first annular seal body 74a, the second annular seal body 74b, and/or the annular stiffener 198 may be positioned to cause the seal 14 to compress and deform in the groove of the first component or the second component when the other of the first component or the second component presses against the first sealing face 78a and the second sealing face 78b in a direction toward the first groove face 76a and the second groove face 76b, thereby to expand the first annular seal body 74a laterally outward from the first lateral face 92 and the second annular seal body 74b outward from the fourth lateral face 152, thereby to enhance the fluid seal between the first component and the second component.

For example, in at least some embodiments consistent with FIGS. 18A and 18B, as a component compresses the seal 14 into the annular groove, the annular stiffener 198 may act as a spacer substantially maintaining separation between the first annular seal body 74a and the second annular seal body 74b. This, in turn, may result in causing the first annular seal body 74a and the second annular seal body 74b deform and expand laterally outward from the first lateral face 80 of the first annular seal body 74a and the fourth lateral face 152 of the second annular seal body 74b as the component compresses and deforms the first annular seal body 74a and the second annular seal body 74b. This deformation may result in causing that first annular seal body 74a and the second annular seal body 74b to substantially fill the annular groove where the first groove side wall 132 meets the groove bottom 130 and where the second groove side wall 134 meets the groove bottom 130 (see, e.g., the example annular groove 70 shown in FIGS. 6A-6C). In addition, as the component compresses and deforms the first annular seal body 74a and the second annular seal body 74b, the first annular seal body 74a and the second annular seal body 74b may deform and expand laterally outward from the first lateral face 80 of the first annular seal body 74a and from the fourth lateral face 152 of the second annular seal body 74b adjacent the open portion 135 of the annular groove. These example activations may result in enhancing the fluid seal between the first component and the second component.

As shown in FIGS. 18A and 18B, the first sealing edge 88a and/or the second sealing edge 88b may be at least partially convex. In some embodiments, the stiffener groove edge 214 may at least partially define a substantially flat surface positioned to face the groove of the first component or the second component. In some embodiments, the first sealing face 78a and/or the second sealing face 78b may have a respective radius larger than a radius of the stiffener sealing face 208 of the annular stiffener 198. In some such embodiments, the first sealing face 78a and/or the second sealing face 78b may contact the other of the first component or the second component before the stiffener sealing face 208 of the annular stiffener 198, for example, when the groove is in an outer diameter of a component having a substantially cylindrical outer surface. In some embodiments, the first sealing face 78a and/or the second sealing face 78b may have a respective radius smaller than the radius of the stiffener sealing face 208 of the annular stiffener 198. In some such embodiments, the first sealing face 78a and/or the second sealing face 78b may contact the other of the first component or the second component before the stiffener sealing face 208 of the annular stiffener 198, for example, when the groove is in an inner diameter of a component having a substantially cylindrical inner surface.

As shown in FIGS. 18A and 18B, in some embodiments, the first groove face 76a, the second groove face 76b, and/or the stiffener groove face 206 may have substantially equal radii. In some embodiments, the first annular seal body 74a and the second annular seal body 74b may include (or be formed from) a first material, and the annular stiffener 198 may include (or be formed from) a second material, with the first material being different than the second material. The first material may have a different hardness than the hardness of the second material. For example, the hardness of the second material may be greater than the hardness of the first material. In some embodiments, the first material and the second material may be substantially the same material.

As shown in FIGS. 18A and 18B, the first lateral edge 92 and fourth lateral edge 158 may be substantially parallel to one another. In some embodiments, the second lateral edge 92 and third lateral edge 156 may be substantially parallel to one another. The first lateral edge 92 and/or the fourth lateral edge 158 may be substantially parallel to the radial axis R of the seal 14. In some embodiments, the second lateral edge 92 and/or the third lateral edge 156 may be substantially parallel to the radial axis R of the seal 14. In some embodiments, for example, as shown in FIGS. 18A and 18B, the first seal cross section 84a, the second seal cross-section 84b, and the stiffener cross-section 190 may have a combined seal cross-section, and the combined seal cross-section may have bilateral symmetry relative to the radial axis R of the seal 14.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application is a divisional of U.S. Non-Provisional application Ser. No. 18/655,707, filed May 6, 2024, titled “SYSTEMS, ASSEMBLIES, APPARATUSES, AND METHODS PROVIDING ENHANCED FLUID SEAL FOR HIGH-POWER PUMPS,” now U.S. Pat. No. 12,650,171, issued Jun. 9, 2026, which claims priority to, and the benefit of U.S. Provisional Application No. 63/500,834, filed May 8, 2023, titled “SYSTEMS, ASSEMBLIES, APPARATUSES, AND METHODS PROVIDING ENHANCED FLUID SEAL FOR HIGH-POWER PUMPS,” the disclosures of which are incorporated herein by reference in their entirety.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A method to enhance a fluid seal between two components of a pump, the method comprising:
inserting an annular seal into an annular groove of a first component of the pump, the annular seal including a groove face and a sealing face opposite the groove face, the groove face, in an undeformed condition, being substantially convex and the sealing face, in the undeformed condition, being substantially concave, the annular groove having a groove cross-section at least partially defined by a bottom of the annular groove, a first side wall of the annular groove, a second side wall of the annular groove opposite the first side wall, and an open portion of the annular groove opposite the bottom of the annular groove and extending between the first side wall and the second side wall, and the inserting resulting in at least a portion of the groove face of the annular seal contacting the bottom of the annular groove and at least a portion of sealing face of the annular seal protruding beyond the open portion of the annular groove;
assembling a second component of the pump relative to the first component of the pump; and
compressing, via the second component, so as to deform the annular seal when positioned in the annular groove, thereby to cause the groove face to abut and substantially fill the bottom of the annular groove and extend from the first side wall to the second side wall, so as to enhance the fluid seal between the first component and the second component.

2. The method of claim 1, wherein the assembling includes assembling the second component of the pump relative to the first component of the pump, thereby to press the second component against the sealing face in a direction toward the groove face, thereby to substantially flatten the sealing face and preload the annular seal in the annular groove, thereby to enhance the fluid seal between the first component and the second component.

3. The method of claim 1, wherein the sealing face comprises a protrusion, and the assembling includes assembling the second component of the pump relative to the first component of the pump, thereby to press the protrusion via the second component in a direction toward the groove face and expand the annular seal laterally outward to preload the annular seal in the annular groove, thereby to enhance the fluid seal between the first component and the second component.

4. The method of claim 1, wherein:
the annular seal includes a first lateral face and a second lateral face opposite the first lateral face, the first lateral face and the second lateral face, in the undeformed condition, extending obliquely relative to one another; and
the assembling includes assembling the second component of the pump relative to the first component of the pump, thereby to deform the annular seal in the annular groove, so that the first lateral face presses against and substantially conforms to the first side wall of the annular groove and the second lateral face presses against and substantially conforms to the second side wall of the annular groove, thereby to enhance the fluid seal between the first component and the second component.

5. The method of claim 1, wherein the inserting includes inserting the annular seal into an annular groove in a substantially cylindrical outer surface of the first component.

6. The method of claim 5, wherein the assembling includes sliding the second component over the substantially cylindrical outer surface of the first component and the annular seal, thereby to deform the annular seal in the annular groove.

7. The method of claim 1, wherein the inserting includes inserting the annular seal into the annular groove in a substantially cylindrical outer surface of one of (a) a cover configured to fit in a port or (b) a sleeve configured to fit into a cylinder.

8. The method of claim 1, wherein the inserting includes inserting the annular seal into the annular groove in a substantially cylindrical inner surface of the first component.

9. The method of claim 8, wherein the assembling includes sliding the second component into the substantially cylindrical inner surface of the first component, thereby to deform the annular seal in the annular groove.

10. The method of claim 1, wherein the inserting includes inserting the annular seal into the annular groove in a substantially cylindrical inner surface of one of (a) a port configured to receive therein a cover or (b) a cylinder configured to receive therein a sleeve.

11. A method of installing a seal in a pump to enhance a fluid seal between two components of the pump, the method comprising:
inserting an annular seal into an annular groove of a first component of the pump, the annular seal including a groove face and a sealing face opposite the groove face, the groove face, in an undeformed condition, being substantially convex and the sealing face, in the undeformed condition, being substantially concave, and the inserting resulting in at least a portion of the groove face of the annular seal contacting a bottom of the annular groove and at least a portion of sealing face of the annular seal protruding beyond an open portion of the annular groove; and
compressing, via a second component of the pump, so as to deform the annular seal when positioned in the annular groove, thereby to cause the groove face to abut and substantially fill a bottom of the annular groove and extend from a first side wall to a second side wall of the annular groove.

12. The method of claim 11, wherein the compressing includes moving the second component relative to the first component, thereby to press the second component against the sealing face in a direction toward the groove face, thereby to substantially flatten the sealing face and preload the annular seal in the annular groove, thereby to enhance the fluid seal between the first component and the second component.

13. The method of claim 11, wherein the sealing face comprises a protrusion, and the compressing includes moving the second component relative to the first component, thereby to press the protrusion via the second component in a direction toward the groove face and expand the annular seal laterally outward to preload the annular seal in the annular groove, thereby to enhance the fluid seal between the first component and the second component.

14. The method of claim 11, wherein:
the annular seal includes a first lateral face and a second lateral face opposite the first lateral face, the first lateral face and the second lateral face, in the undeformed condition, extending obliquely relative to one another; and
the compressing includes moving the second component relative to the first component, thereby to deform the annular seal in the annular groove, so that the first lateral face presses against and substantially conforms to the first side wall of the annular groove and the second lateral face presses against and substantially conforms to the second side wall of the annular groove, thereby to enhance the fluid seal between the first component and the second component.

15. The method of claim 11, wherein the compressing includes sliding the second component over a substantially cylindrical outer surface of the first component and the annular seal, thereby to deform the annular seal in the annular groove.

16. The method of claim 11, wherein the inserting includes inserting the annular seal into the annular groove in a substantially cylindrical outer surface of one of (a) a cover configured to fit in a port or (b) a sleeve configured to fit into a cylinder.

17. The method of claim 11, wherein the compressing includes sliding the second component into a substantially cylindrical inner surface of the first component, thereby to deform the annular seal in the annular groove.

18. The method of claim 11, wherein the inserting includes inserting the annular seal into the annular groove in a substantially cylindrical inner surface of one of (a) a port configured to receive therein a cover or (b) a cylinder configured to receive therein a sleeve.
